(19) United States
(12) Patent Application Publication
(10) Pub. No.: US 2025/0139322 A1
(43) Pub. Date: May 1, 2025

(54) RECURSIVELY MAPPED GEOMETRY OF ADDITIVELY MANUFACTURED PART

(71) Applicant: The Boeing Company, Arlington, VA (US)

(72) Inventor: Michael C. Elford, Brisbane (AU)

(21) Appl. No.: 18/496,668

(22) Filed: Oct. 27, 2023

(51) Int. Cl. G06F 30/17

(52) U.S. Cl. CPC G06F 30/17

(57) ABSTRACT

A method of generating a recursively mapped infill geometry for an additively manufacturable part. The method includes receiving a base unit cell mesh including a plurality of base quadrilateral elements. In each of a plurality of iterations, the method further includes receiving a target unit cell mesh including target quadrilateral elements. In each iteration, the method further includes generating a target hexahedral unit cell mesh including target hexahedral elements by extruding the target quadrilateral elements. In each of the iterations, the method further includes generating a recursive supercell mesh by mapping each of the base quadrilateral elements onto a target hexahedral element. If the current iteration is not a final iteration, the method further includes setting the recursive supercell mesh as the base unit cell mesh used in a subsequent iteration. The method further includes outputting a recursively mapped unit cell mesh including a final recursive supercell mesh.

### FIELD

The present disclosure relates generally to additive manufacturing and relates specifically to the additive manufacturing of sandwich panels.

### BACKGROUND

Additive manufacturing (also known as 3D printing) is a manufacturing approach in which a component is constructed by iteratively depositing a material on a surface of the component. In contrast to other manufacturing techniques, such as forming or subtractive manufacturing, additive manufacturing allows a wider variety of geometries to be produced.

### SUMMARY

According to one aspect of the present disclosure, a method of generating a recursively mapped infill geometry for an additively manufacturable part is provided. The method includes receiving a base unit cell mesh that defines a base unit cell surface geometry. The base unit cell mesh includes a plurality of base quadrilateral elements. In each of a plurality of iterations, the method further includes receiving a target unit cell mesh that defines a target unit cell surface geometry of a current iteration of the plurality of iterations. The target unit cell mesh includes a plurality of target quadrilateral elements. In each of the iterations, the method further includes generating a target hexahedral unit cell mesh including a plurality of target hexahedral elements at least in part by extruding the plurality of target quadrilateral elements. In each of the iterations, the method further includes generating a recursive supercell mesh at least in part by mapping each of the base quadrilateral elements onto a respective target hexahedral element of the plurality of target hexahedral elements included in the target hexahedral unit cell mesh. If the current iteration is not a final iteration of the plurality of iterations, the method further includes setting the recursive supercell mesh of the current iteration as the base unit cell mesh to be used in a subsequent iteration. The method further includes outputting a recursively mapped unit cell mesh including a final recursive supercell mesh computed in the final iteration.

### BRIEF DESCRIPTION OF THE DRAWINGS

FIG. 1A shows a flowchart of a method of generating a recursively mapped unit cell mesh for an additively manufactured part, according to one example embodiment.

FIG. 1B shows additional steps that are performed at the computing system in some examples when generating a recursive unit cell mesh, according to the example of FIG. 1A.

FIG. 1C shows additional steps that are performed at the computing system in some examples when generating a recursive unit cell mesh, according to the example of FIG. 1A.

FIG. 1D shows additional steps of the method of FIG. 1A that are performed at an additive manufacturing device.

FIG. 2A schematically shows a cube in isoparametric space, according to the example of FIG. 1A.

FIG. 2B schematically shows an example quadratic hexahedral element in a Cartesian space, according to the example of FIG. 1A.

FIG. 2C shows an example base unit cell mesh configured to fit within the cube of FIG. 2A.

FIG. 2D shows an example of a mapped base unit cell mesh computed by mapping the example base unit cell mesh of FIG. 2C from the isoparametric space of FIG. 2A to the Cartesian space of FIG. 2B.

FIG. 3A shows an example of a triply periodic minimal surface that has a gyroid geometry, according to the example of FIG. 1A.

FIG. 3B shows an example target unit cell mesh generated to have a target unit cell surface geometry that discretizes the gyroid triply periodic minimal surface of FIG. 3A.

FIG. 3C shows an example target hexahedral unit cell mesh generated by extruding target quadrilateral elements included in the target unit cell mesh of FIG. 3B. The hexahedral elements are shown slightly shrunken for clarity.

FIG. 3D shows an example type <Gyroid, Schwarz-P> level 1 recursive supercell generated from the Schwarz-P base unit cell quadrilateral unit cell mesh with a first target unit cell hexahedral mesh of a Gyroid triply periodic minimal surface shown in the example of FIG. 3C.

FIG. 3E shows another example type <Gyroid, Schwarz-P> level 1 recursive supercell that includes a first skin and a second skin, according to the example of FIG. 1A.

FIG. 4A shows another example target unit cell mesh generated to have a target unit cell surface geometry that discretizes the gyroid triply periodic minimal surface of FIG. 3A and includes more quadrilaterals than the unit cell mesh shown in FIG. 3B.

FIG. 4B shows an example target hexahedral unit cell mesh that includes a plurality of target hexahedral elements generated by extruding the target quadrilateral elements of FIG. 4A. The hexahedral elements are shown slightly shrunken for clarity.

FIG. 4C shows an example type <Gyroid, Connectable Cuboid> level 1 recursive supercell generated from the base connectable cuboid unit cell quadrilateral unit cell mesh with a first target unit cell hexahedral mesh of a gyroid periodic surface as shown in the example of FIG. 4B.

FIG. 4D shows another example type <Gyroid, Connectable Cuboid> level 1 recursive supercell that is generated from the target hexahedral unit cell mesh of FIG. 4B and includes a first skin and a second skin.

FIG. 5A shows another example target unit cell mesh generated to have a target unit cell surface geometry that discretizes the gyroid triply periodic minimal surface of FIG. 3A and includes fewer quadrilaterals than the unit cell mesh shown in FIG. 3B.

FIG. 5B shows an example target hexahedral unit cell mesh generated from the gyroid target unit cell mesh of FIG. 5A. The hexahedral elements are shown slightly shrunken for clarity.

FIG. 5C shows example type <Gyroid, Multi-Layer Schwarz-P> level 1 recursive supercell generated from the base multi-layer Schwarz-P unit cell quadrilateral unit cell mesh with a first target hexahedral unit cell mesh of a gyroid triply periodic minimal surface as shown in the example of FIG. 5B.

FIG. 5D shows an example type <Gyroid, Multi-Layer Schwarz-P> level 1 recursive supercell that is generated from the target hexahedral unit cell mesh of FIG. 5B and a multi-layer Schwarz-P base quadrilateral unit cell mesh, which includes a first skin and a second skin.

FIG. 6A shows an example triply periodic minimal surface that has a Schwarz-P geometry, according to the example of FIG. 1A.

FIG. 6B shows an example target unit cell mesh generated to have the Schwarz-P geometry of the triply periodic minimal surface of FIG. 6A.

FIG. 6C shows an example target hexahedral unit cell mesh generated from the target unit cell mesh of FIG. 6B. The hexahedral elements are shown slightly shrunken for clarity.

FIG. 6D shows an example type <Schwarz-P, Schwarz-P> level 1 recursive supercell generated from a Schwarz-P base quadrilateral unit cell mesh with a first target unit cell hexahedral mesh of a Schwarz-P triply periodic minimal surface as shown in the example of FIG. 6B.

FIG. 6E shows another example <Schwarz-P, Schwarz-P> level 1 recursive supercell that is generated from the target hexahedral unit cell mesh of FIG. 6B and includes a first skin and a second skin.

FIG. 7A shows another example target unit cell mesh that is generated from the Schwarz-P triply periodic minimal surface of FIG. 6A and includes fewer quadrilateral elements than the unit cell mesh shown in FIG. 6B.

FIG. 7B shows an example target hexahedral unit cell mesh generated from the target unit cell mesh of FIG. 7A, where the extruded thickness of the hexahedral unit cell mesh of FIG. 7B is larger than the extruded thickness of the hexahedral unit cell mesh of FIG. 6B. The hexahedral elements are shown slightly shrunken for clarity.

FIG. 7C shows an example type <Schwarz-P, Schwarz-P> level 1 recursive supercell generated from the Schwarz-P base quadrilateral unit cell mesh with a first target unit cell hexahedral mesh of a Schwarz-P triply periodic minimal surface as shown in the example of FIG. 7A.

FIG. 7D shows another example type <Schwarz-P, Schwarz-P> level 1 recursive supercell that is generated from the target hexahedral unit cell mesh of FIG. 7B and includes a first skin and a second skin.

FIG. 8A shows an example triply periodic surface that has a connectable cuboid geometry, according to the example of FIG. 1A.

FIG. 8B shows an example target unit cell mesh generated to conform to the triply periodic surface of FIG. 8A.

FIG. 8C shows an example target hexahedral unit cell mesh generated using the target unit cell mesh of FIG. 8B. The hexahedral elements are shown slightly shrunken for clarity.

FIG. 8D shows an example type <Connectable Cuboid, Connectable Cuboid> level 1 recursive supercell generated from the connectable cuboid unit cell mesh of FIG. 8C and includes a first skin and a second skin.

FIG. 8E shows an example type <Connectable Cuboid, Schwarz-P> level 1 recursive supercell generated from the connectable cuboid unit cell mesh of FIG. 8C and includes a first skin and a second skin.

FIG. 9A shows an example mid-surface driver mesh that defines a mid-surface of a sandwich panel geometry and includes a plurality of driver mesh quadrilateral elements (right half) and associated hexahedral elements (left half), according to the example of FIG. 1B. The quadrilateral and hexahedral elements are shown slightly shrunken for clarity.

FIG. 9B shows an example sandwich panel geometry computed using the mid-surface driver mesh of FIG. 9A, where the unit cells are type <Schwarz-P, Schwarz-P> level 1 recursive supercells.

FIG. 9C shows the example sandwich panel of FIG. 9B without a first and second skin, thereby providing a view of the sandwich panel infill geometry.

FIG. 9D shows an inset view of a portion of the sandwich panel infill geometry, according to the example of FIG. 9C.

FIG. 10A shows a 2×2×2 array of type <Schwarz-P, Schwarz-P> level 1 recursive supercells.

FIG. 10B shows an example part geometry of an additively manufacturable part generated by computing a Boolean intersection of a solid sphere and a set of points that form an array of the recursive supercells shown in FIG. 10A.

FIG. 11A shows a target hexahedral unit cell mesh including a plurality of target hexahedral elements that conform to the geometry of the gyroid triply periodic minimal surface shown in FIG. 3A. The hexahedral elements are shown slightly shrunken for clarity.

FIG. 11B shows an example type <Gyroid, Schwarz-P, Schwarz-P> level 2 recursive supercell generated from the <Schwarz-P, Schwarz-P> level 1 recursive supercell base unit cell mesh of quadrilateral elements of FIG. 6E and the gyroid target unit cell hexahedral mesh of FIG. 11A.

FIG. 12A schematically shows a computing system that is configured to compute a recursively mapped unit cell mesh, according to the example of FIG. 1A.

FIG. 12B schematically shows the computing system of FIG. 12A when additional computing processes are performed to generate a part geometry and manufacture an additively manufacturable part.

FIG. 13A schematically shows a split ring resonator base unit cell configured to be included in a metamaterial infill as a base unit cell, according to the example of FIG. 12A.

FIG. 13B schematically shows a metamaterial infill structured as a split ring resonator that includes a plurality of split ring resonator base unit cells, according to the example of FIG. 12A.

FIG. 14 schematically shows an example computing environment in which the computing system of FIGS. 12A-12B is instantiated.

### DETAILED DESCRIPTION

Additive manufacturing has recently been used when manufacturing the infills of parts such as sandwich panels. Since additive manufacturing enables the use of geometries that would be impractical to achieve with other manufacturing techniques, parts that include additively manufactured infills sometimes achieve lower weights and higher strength-to-weight ratios than equivalent parts manufactured via other approaches. Devices and methods for additively manufacturing an infill of a part, such as a sandwich panel, are provided below.

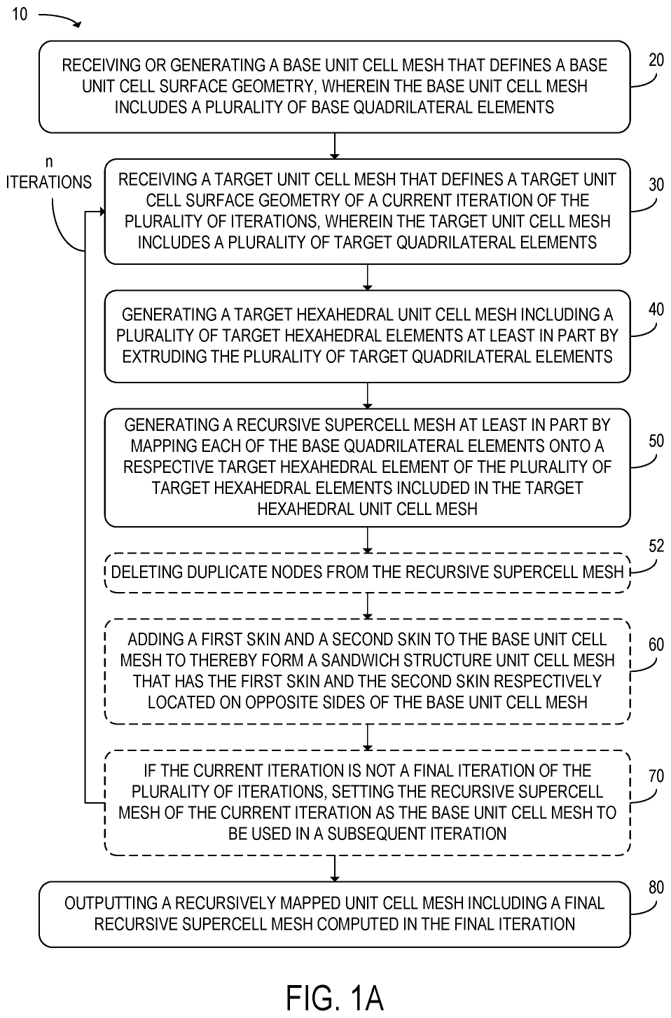

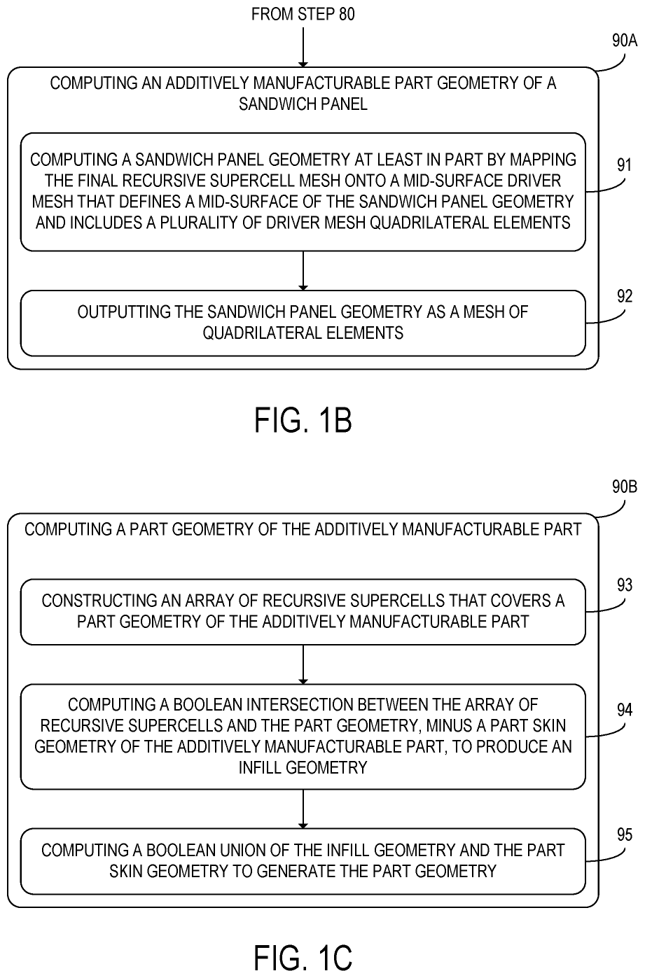

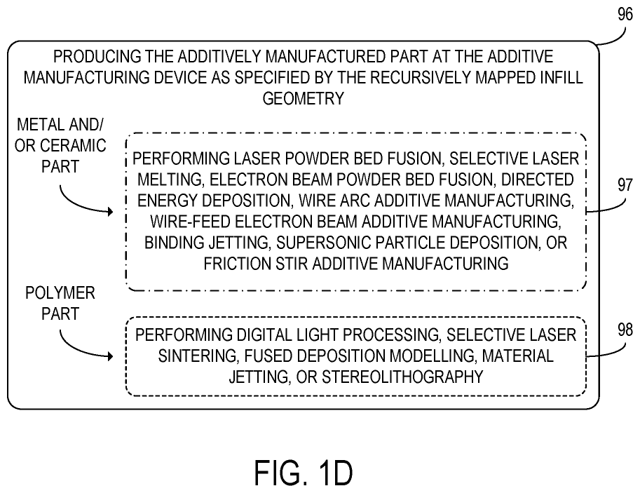

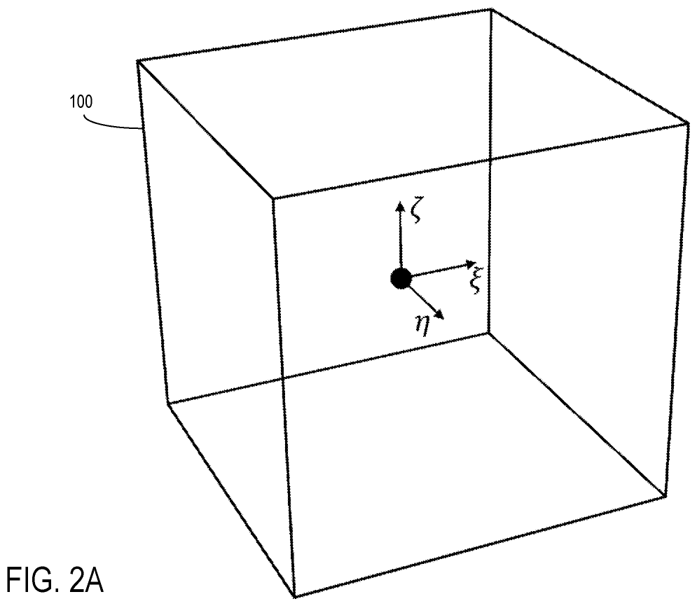

FIG. 1A shows a flowchart of a method 10 of generating a recursively mapped unit cell mesh for an additively manufactured part. The method 10 of FIG. 1A is performed at a computing system that is configured to output the recursively mapped unit cell mesh for use in an infill pattern of an additively manufactured part. For example, the infill pattern may be a background infill pattern or a mapped infill pattern. Accordingly, the additively manufactured part has an infill that is specified by the recursively mapped unit cell mesh.

At step 20, the method 10 includes receiving or generating a base unit cell mesh with a base unit cell surface geometry. The base unit cell mesh includes a plurality of base quadrilateral elements that conform to the base unit cell surface geometry. In some examples, the base unit cell surface geometry is a 2-manifold. As discussed below, the base unit cell surface geometry is a mesh of quadrilateral elements.

In some examples, the base unit cell mesh that includes the base quadrilateral elements is generated by performing a meshing algorithm on a periodic segment of a level set surface. For example, the base unit cell surface geometry can be a level set surface which is a gyroid geometry, a Schwarz-P geometry or a connectable cuboid geometry. Gyroid and Schwarz-P triply periodic surfaces are minimal surfaces, meaning they have zero mean curvature everywhere on the surface.

A periodic segment of a gyroid surface geometry is defined as a set S_{gyr}, where:

$$( Equation 1 )$$

$${{S}_{gyr} = \{ ( x , y , z ) ∈ [ - 1 , 1 )}^{3} \vert cos ( π x ) sin ( π y ) + cos ( π y ) sin ( π z ) + cos ( π z ) sin ( π x ) = 0 \}$$

A periodic segment of a Schwarz-P geometry is defined as a set Sₛₚ, where:

$${{S}_{sp} = \{ ( x , y , z ) ∈ [ - 1 , 1 )}^{3} \vert cos ( π x ) + cos ( π y ) + cos ( π z ) = 0 \} \qquad ( Equation 2 )$$

A periodic segment of a connectable cuboid geometry is defined as a set S_{cc}, where:

$$( Equation 3 )$$

$${{S}_{cc} = \{ ( x , y , z ) ∈ [ - 1 , 1 )}^{3} \vert cos ( π x ) cos ( π y ) + cos ( π y ) cos ( π z ) + cos ( π z ) cos ( π x ) = - 0.5 \}$$

In such examples, a quadrilateral mesh may be obtained by first applying a marching cubes or marching tetrahedrons algorithm to first obtain a first mesh including a first plurality of triangular elements. The first mesh can then be resampled using, for example, an Approximated Centroidal Voronoi Diagrams (ACVD) algorithm, to obtain a second mesh with a second plurality of triangular elements. The second plurality of triangular elements can subsequently be combined to form a quadrilateral mesh that includes a plurality of quadrilateral elements. In some examples, this combining is performed using a Blossom recombination algorithm.

In other examples, the mesh is generated using a Computer Aided Design (CAD) surface as input into a quadrilateral meshing algorithm. In such examples, the surface is defined as a contiguous collection of one or more trimmed parametric surfaces. The plurality of trimmed parametric surfaces are then meshed to obtain a quadrilateral unit cell mesh including a plurality of quadrilateral elements. In other examples, the unit cell mesh is directly input to the computing system as a plurality of quadrilateral elements.

Steps 30, 40, 50, 60, and 70 of the method 10 are performed in each of a plurality of iterations. The number of iterations n may be specified by the user. These steps are performed in a loop, such that steps 30, 40, and 50, and optionally step 60 and/or step 70, are performed in each of the n iterations.

At step 30, the method 10 further includes receiving or generating a target unit cell mesh that defines a target unit cell surface geometry of a current iteration of the plurality of iterations. The target unit cell mesh includes a plurality of target quadrilateral elements. These target quadrilateral elements are used to define a structure of the recursively mapped unit cell mesh at a coarser level than that of the base unit cell mesh. However, the base unit cell mesh and the target unit cell mesh are defined over domains of the same size, such as a 2×2×2 cube. In some examples, the base unit cell geometry has a same geometry as the target unit cell geometry such that the geometry is used to generate meshes for both the base unit cell mesh and the target unit cell mesh. In a subset of these examples, the base unit cell mesh and the target unit cell mesh of quadrilaterals are the same mesh. In a different subset of these examples, the base unit cell mesh and target unit cell mesh are different, but the base unit cell geometry and the target unit cell geometry are the same. In other examples, the base and target unit cell geometries and meshes are different. Similarly to the base unit cell surface geometry, the target unit cell surface geometry may be a triply periodic surface such as a gyroid geometry, a Schwarz-P geometry or a connectable cuboid geometry. The triply period surface is, in some examples, defined by a periodic segment of a level set. In other examples, the unit cell surface geometry is defined by a CAD file. In such examples, a mesh including a plurality of quadrilateral elements is obtained through the application of one or more meshing algorithms. The target unit cell mesh is directly supplied by the user in other examples.

At step 40, the method 10 further includes generating a target hexahedral unit cell mesh including a plurality of target hexahedral elements. The target hexahedral unit cell mesh is generated at least in part by extruding the plurality of target quadrilateral elements along a direction locally perpendicular to the target unit cell geometry.

At step 50, the method 10 further includes generating a level n supercell mesh, where n is an iteration number of the current iteration. This supercell mesh is generated at least in part by mapping each of the base quadrilateral elements onto a respective target hexahedral element of the plurality of target hexahedral elements included in the target hexahedral unit cell mesh. The mapping between the base quadrilateral elements and the target hexahedral elements is defined by a plurality of basis functions defined on the target quadrilateral or hexahedral elements.

In some examples, at step 52, the method 10 further includes deleting a plurality of duplicate nodes from the recursive supercell mesh. These duplicate nodes occur when nodes of the base quadrilateral elements are mapped to the same locations in the recursive unit cell mesh.

In some examples, at step 60, the method 10 further optionally includes adding a first skin and a second skin to the base unit cell mesh. Adding the first skin and the second skin forms a sandwich structure unit cell mesh that has the first skin and the second skin respectively located on opposite sides of the base unit cell mesh.

Step 70 is performed when the current iteration is not a final iteration of the plurality of iterations. At step 70, the method 10 further includes setting the recursive supercell mesh of the current iteration as the base unit cell mesh to be used in a subsequent iteration. Thus, the recursive supercell mesh is used to form the fine-scale structure of a larger-scale target hexahedral mesh in such examples.

At step 80, the method 10 further includes outputting a recursively mapped unit cell mesh including a final recursive supercell mesh computed in the final iteration. This recursively mapped supercell mesh can then be used to generate the infill for an additively manufactured part via mapping onto a driver mesh or by cropping of a background mesh, as discussed in more detail below.

FIG. 1B shows additional steps that are performed at the computing system after generating the recursive supercell mesh. In the example of FIG. 1B, the method 10 further includes step 90A, which is performed after step 80. At step 90A, the method 10 further includes computing an additively manufacturable part geometry of a sandwich panel. Step 90A may include, at step 91, computing a sandwich panel geometry at least in part by mapping the final recursive supercell mesh onto a mid-surface driver mesh. The mid-surface driver mesh is a discrete approximation of a mid-surface driver geometry. The mid-surface driver mesh defines a mid-surface of the sandwich panel geometry and includes a plurality of driver mesh quadrilateral elements. Thus, the final recursively mapped unit cell mesh is used to generate a sandwich panel mesh. In the example of FIG. 1B, step 90A of the method 10 further includes step 92. At step 92, the method 10 further includes outputting the sandwich panel geometry as a mesh of quadrilateral elements. This mesh represents a sandwich panel geometry that is formed from recursively mapped supercells.

FIG. 1C shows additional steps of the method 10 that are performed in some examples after the recursive supercell mesh is computed and as an alternative to the steps of FIG. 1B. In the example of FIG. 1C, the additively manufactured part can have a geometry other than a sandwich panel geometry. At step 90B, the method 10 further includes computing a part geometry of the additively manufacturable part which has a recursive supercell infill. Computing the part geometry includes, at step 93, constructing an array of recursive supercells that covers a part geometry of the additively manufacturable part. At step 94, step 90B further includes computing a Boolean intersection between the array of recursive supercells and the part geometry, minus a part skin geometry of the additively manufacturable part. Computing this Boolean intersection produces an infill geometry of the additively manufacturable part. At step 95, step 90B further includes computing a Boolean union of the infill geometry and the part skin geometry to generate the part geometry. Thus, the skin geometry is added back into the part geometry after the infill geometry is computed.

FIG. 1D shows additional steps of the method 10 that are performed at the additive manufacturing device subsequently to either step 90A or step 90B. At step 96, the method 10 further includes producing the additively manufactured part at the additive manufacturing device as specified by the recursively mapped unit cell mesh. In examples in which the additively manufactured part is formed from metal, ceramic, or a combination thereof, step 96 can include step 97. At step 97, step 96 includes performing one or more of laser powder bed fusion, selective laser melting, electron beam powder bed fusion, directed energy deposition, wire arc additive manufacturing, wire-feed electron beam additive manufacturing, binding jetting, supersonic particle deposition, and friction stir additive manufacturing. In examples in which the additively manufactured part is formed from a polymer, step 96 can include step 98. At step 98, step 96 includes performing one or more of digital light processing, selective laser sintering, fused deposition modelling, material jetting, and stereolithography. In other examples, other materials and/or additive manufacturing techniques can be used.

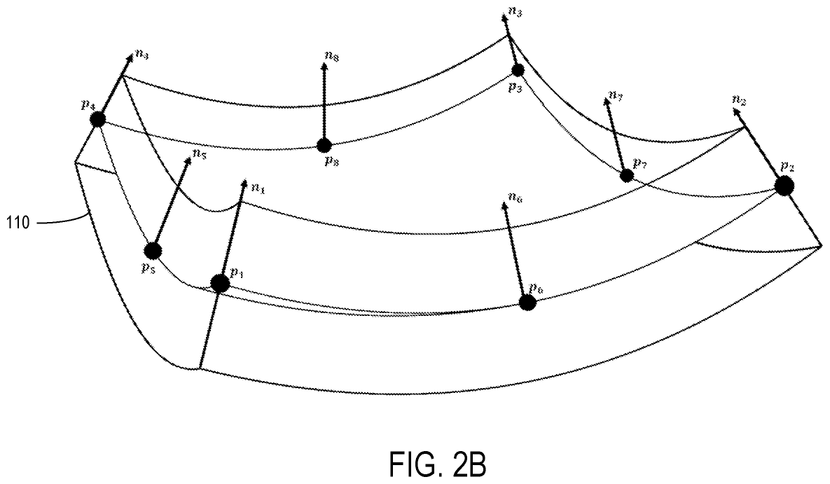

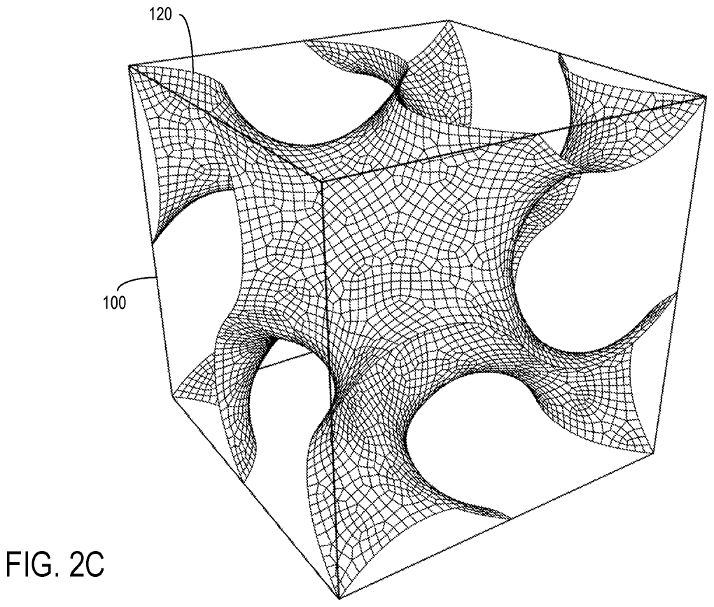

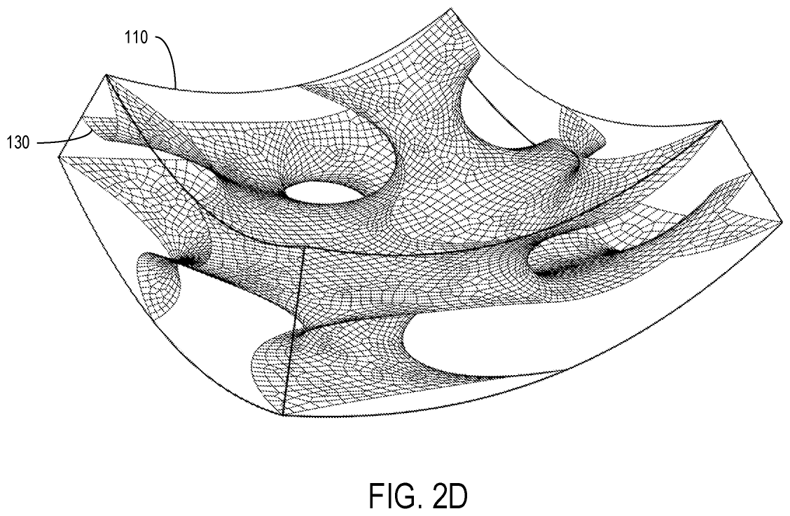

The mapping of the base quadrilateral elements onto the target hexahedral elements using basis functions is discussed below with reference to FIGS. 2A-2B. FIG. 2A schematically shows a cube 100 represented in isoparametric space. Positions in the isoparametric space are defined by coordinates (ξ, η, ζ). FIG. 2B schematically shows an example quadratic hexahedral element 110 represented in a Cartesian space. Positions in the Cartesian space are defined by coordinates (x,y,z). The quadratic hexahedral element 110 is generated by extruding a quadratic quadrilateral element, which is also defined in the Cartesian space. The quadratic quadrilateral element is a mid-surface from which the extrusion is defined in direction locally normal to the quadratic quadrilateral element, both above and below the quadratic quadrilateral element. The hexahedral element 110 shown in the example of FIG. 2B is defined using a set of eight points p₁ . . . p₈ located along a mid-surface of the hexahedral element 110. These eight points include four corner nodes and four mid-side nodes.

FIG. 2C schematically shows a base unit cell mesh 120 located within the cube 100 of FIG. 2A. Mapping the base unit cell mesh 120 located within the cube 100 into Cartesian space includes computing averaged normal vectors n₁ . . . n₈ at points p₁ . . . p₈. Components of the averaged normal vectors n₁ . . . n₈ located at the four corner nodes are computed with the following equations:

$${n}_{x} = {\sum }_{i = 1}^{k} {A}_{i} {n}_{{i}_{x}}$$

$${n}_{y} = {\sum }_{i = 1}^{k} {A}_{i} {n}_{{i}_{y}}$$

$${n}_{z} = {\sum }_{i = 1}^{k} {A}_{i} {n}_{{i}_{z}}$$

In the above equations, k is the number of elements connected to a given corner node. Aᵢ is an area of an i^{th} connecting element in some examples. In other examples, Aᵢ is set to 1. The components nᵢ_{ₓ}, nᵢ_{_{y}}, and nᵢ_{_{z}} are the x, y, and z components of the i^{th} connecting element normal, respectively. For the four mid-side nodes, the normals are each computed as vectoral averages of the two neighboring corner node averaged normal vectors.

The base unit cell mesh 120 is mapped into a Cartesian space using basis functions, as discussed above. The basis functions are defined as follows in the example of FIGS. 2A-2B:

$${N}_{1} = \frac{1}{4} ( 1 - ξ ) ( 1 - η ) ( - ξ - η - 1 )$$

$${N}_{2} = \frac{1}{4} ( 1 + ξ ) ( 1 - η ) ( ξ - η - 1 )$$

$${N}_{3} = \frac{1}{4} ( 1 + ξ ) ( 1 + η ) ( ξ + η - 1 )$$

$${N}_{4} = \frac{1}{4} ( 1 - ξ ) ( 1 + η ) ( - ξ + η - 1 )$$

$${N}_{5} = \frac{1}{2} ( 1 - η ) ( 1 + ξ ) ( 1 - ξ )$$

$${N}_{6} = \frac{1}{2} ( 1 + η ) ( 1 + ξ ) ( 1 - η )$$

$${N}_{7} = \frac{1}{2} ( 1 + η ) ( 1 + ξ ) ( 1 - ξ )$$

$${N}_{8} = \frac{1}{2} ( 1 + η ) ( 1 - ξ ) ( 1 - η )$$

In the example of FIGS. 2A-2B, the basis functions N₁ . . . N₈ are further used to compute a respective normal vector n=(nₓ, n_{y}, n_{z})^{T} of the base quadrilateral element. The following equations can be used to compute the components of the normal vector:

$${n}_{x} = {\sum }_{i = 1}^{8} {N}_{i} {n}_{{i}_{x}}$$

$${n}_{y} = {\sum }_{i = 1}^{8} {N}_{i} {n}_{{i}_{y}}$$

$${n}_{z} = {\sum }_{i = 1}^{8} {N}_{i} {n}_{{i}_{z}}$$

In the above equations, nᵢ_{ₓ}, nᵢ_{_{y}}, and nᵢ_{_{z}} are the x, y, and z components of averaged normal vectors n₁ . . . n₈ computed at nodes of the base quadrilateral element.

The nodes of the base quadrilateral element have position vectors p₁ . . . p₈. After computing the components nₓ, n_{y}, and n_{z} of the normal vector n, the position vectors of the nodes of the mapped base unit cell mesh are computed using the following equations:

$${p}_{x} = {\sum }_{i = 1}^{8} {N}_{i} {p}_{{i}_{x}} + \frac{1}{2} ζ {n}_{x} t$$

$${p}_{y} = {\sum }_{i = 1}^{8} {N}_{i} {p}_{{i}_{y}} + \frac{1}{2} ζ {n}_{y} t$$

$${p}_{z} = {\sum }_{i = 1}^{8} {N}_{i} {p}_{{i}_{z}} + \frac{1}{2} ζ {n}_{z} t$$

In the above equations, pᵢ_{ₓ}, pᵢ_{_{y}}, and pᵢ_{_{z}} are respectively the x, y, and z components (relative to the Cartesian coordinate system) of nodes in the mapped base unit cell mesh, and t is the sandwich panel overall thickness (i.e. the height of the sandwich panel). Accordingly, the position vectors of the mapped recursive supercell mesh are computed by mapping the position vectors of the base recursive supercell mesh onto each of the plurality of hexahedral elements included in the target hexahedral mesh.

The base unit cell geometry of the base unit cell mesh 120 shown in the example of FIG. 2C is a gyroid geometry. FIG. 2D further shows an example of a mapped gyroid base unit cell mesh 130 computed from the example base unit cell mesh 120 of FIG. 2C using the basis functions associated with the hexahedral element of FIG. 2B.

Although the above example of FIGS. 2A-2D illustrates the use of quadratic basis functions, alternative embodiments may utilize linear, cubic, quartic, or, in general n^{th}-order polynomial basis functions. In some embodiments, these basis functions are the dyadic (tensor) product of one-dimensional Lagrange polynomials.

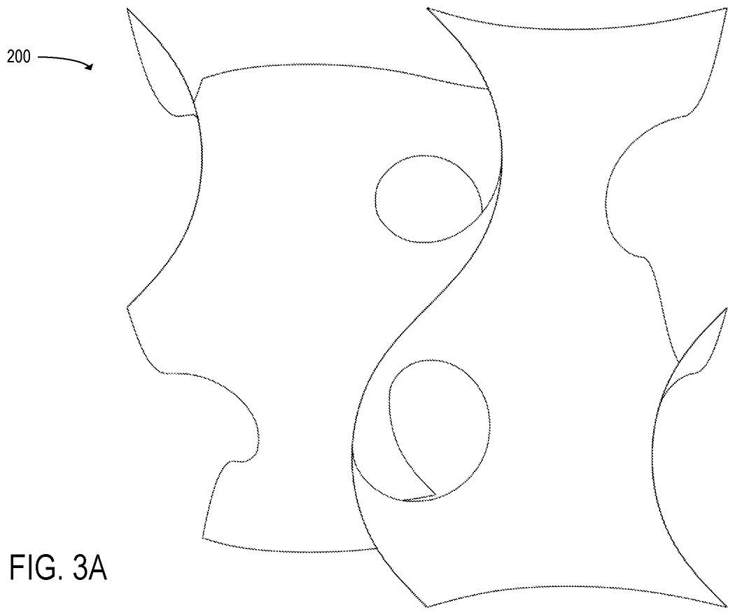

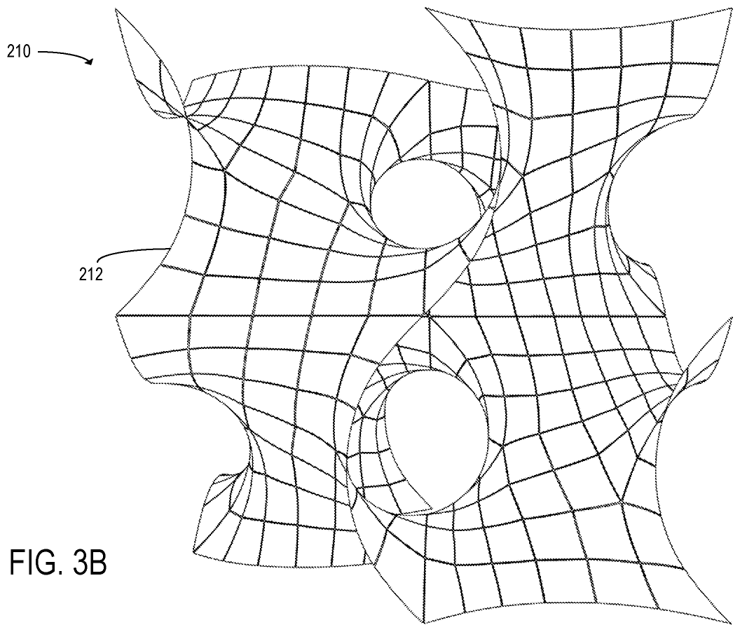

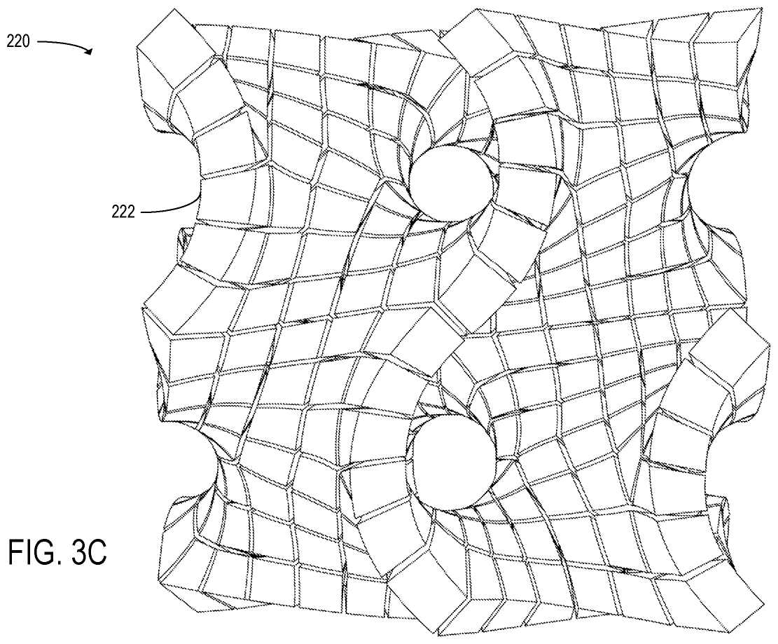

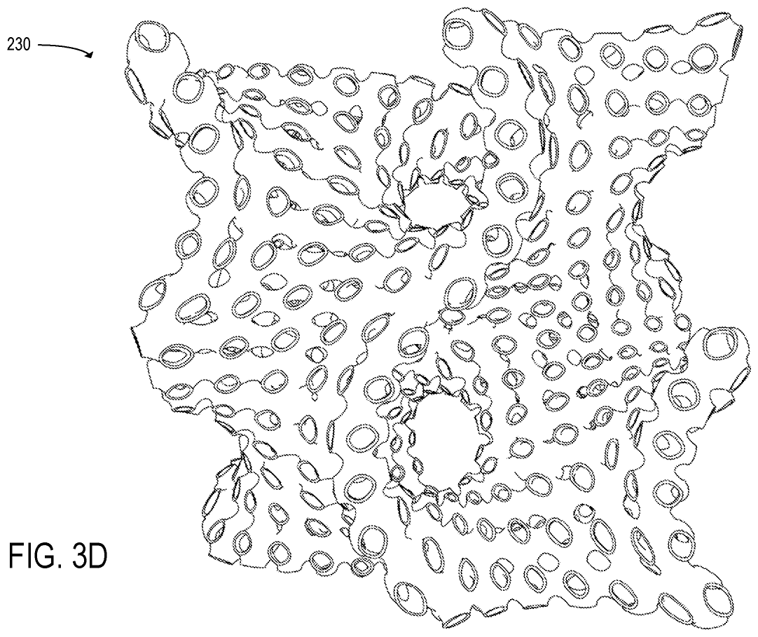

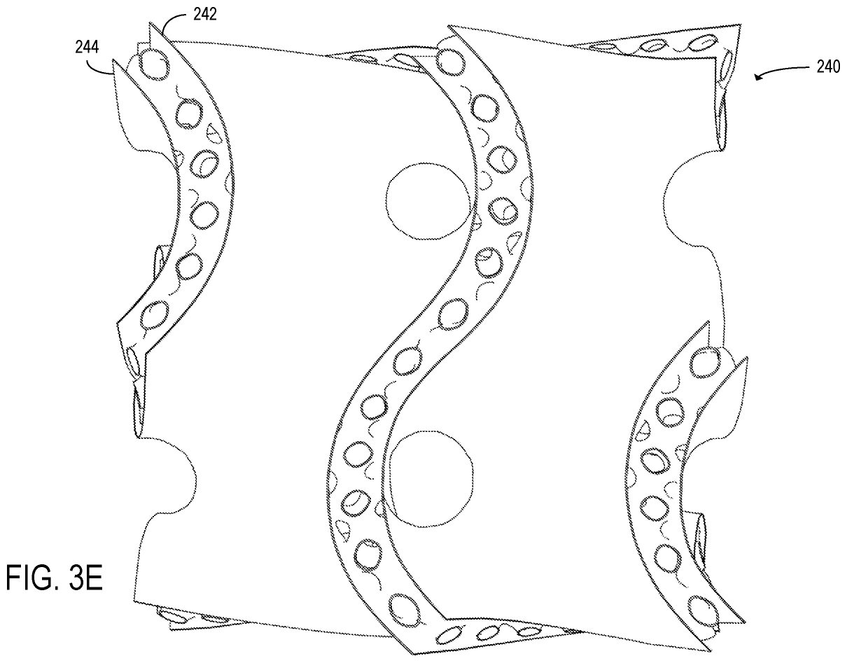

FIG. 3A shows an example of a triply periodic minimal surface 200. The triply periodic minimal surface 200 is a gyroid, as defined by Equation 1, in the example of FIG. 1A. FIG. 3B shows an example target unit cell mesh 210 generated using the triply periodic minimal surface 200 of FIG. 3A. The target cell mesh 210 includes a plurality of target quadrilateral elements 212.

FIG. 3C shows an example target hexahedral unit cell mesh 220 generated by extruding the target quadrilateral elements included in the target unit cell mesh 210. The target hexahedral unit cell mesh 220 includes a plurality of target hexahedral elements 222. In FIG. 3C, the hexahedral elements 222 are shown slightly shrunken for clarity.

FIG. 3D shows example type <Gyroid, Schwarz-P> level 1 recursive supercell 230 generated using a Schwarz-P base unit cell mesh. The Schwarz-P base unit cell mesh has been mapped onto each of the hexahedral elements in the gyroid target hexahedral unit cell mesh shown in the example of FIG. 3C. The recursive supercell 230 of FIG. 3D can be included in a mapped geometry along with a plurality of additional instances of the supercell 230. For example, in some examples, a plurality of supercells 230 are used to construct a sandwich panel structure. The supercell 230 is generated with a Schwarz-P base unit cell surface geometry and a gyroid target unit cell surface geometry, as indicated with the notation <Gyroid, Schwarz-P> level 1. In this notation, the bracketed terms are a vector of unit cell geometries in order of mapping, with the base unit cell at the end of the list, and level 1 indicates that n=1 in the method 10. Thus, the supercell 230 has a Schwarz-P fine-scale structure and a gyroid large-scale structure.

Although the supercell 230 is shown without skins in the example of FIG. 3D, a first skin and a second skin are provided in examples in which step 60 of the method 10 is performed. FIG. 3E shows another example supercell 240 that is identical to that of FIG. 3D, except for the inclusion of a first skin 242 and a second skin 244 on opposite sides of the schwarz-P unit cell that forms the small scale structure of the supercell 240.

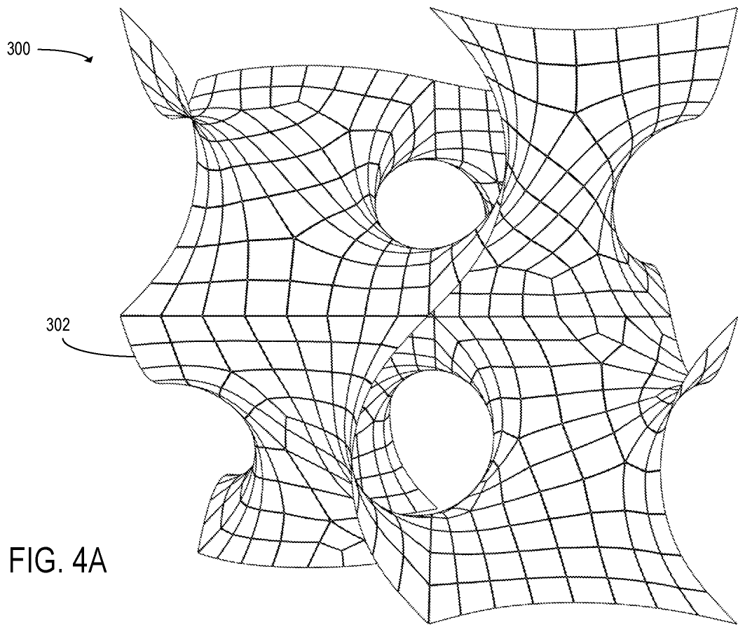

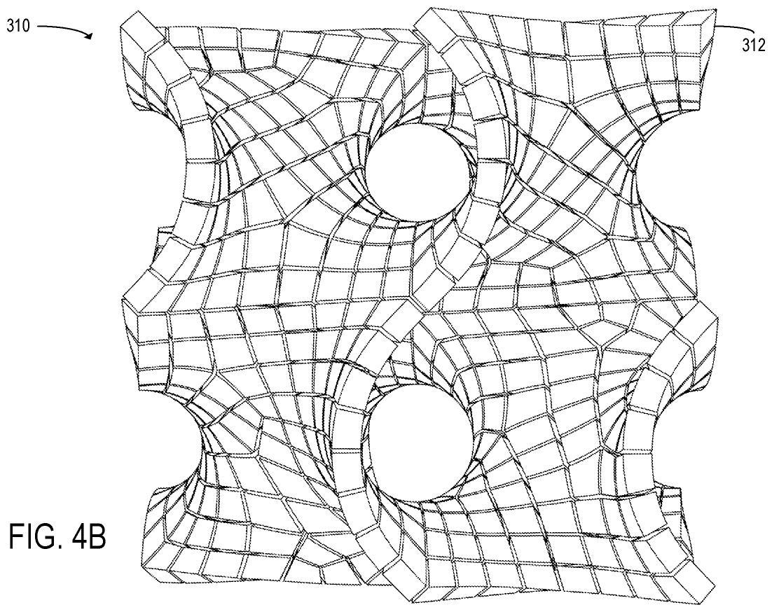

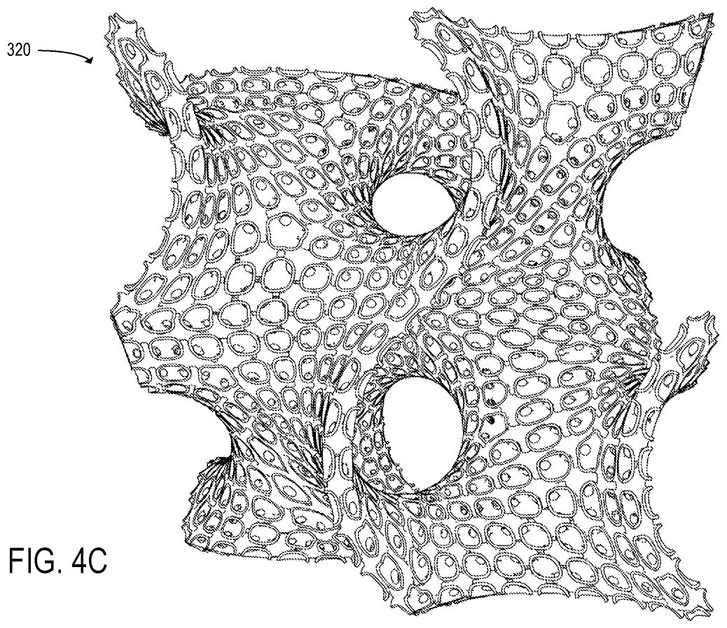

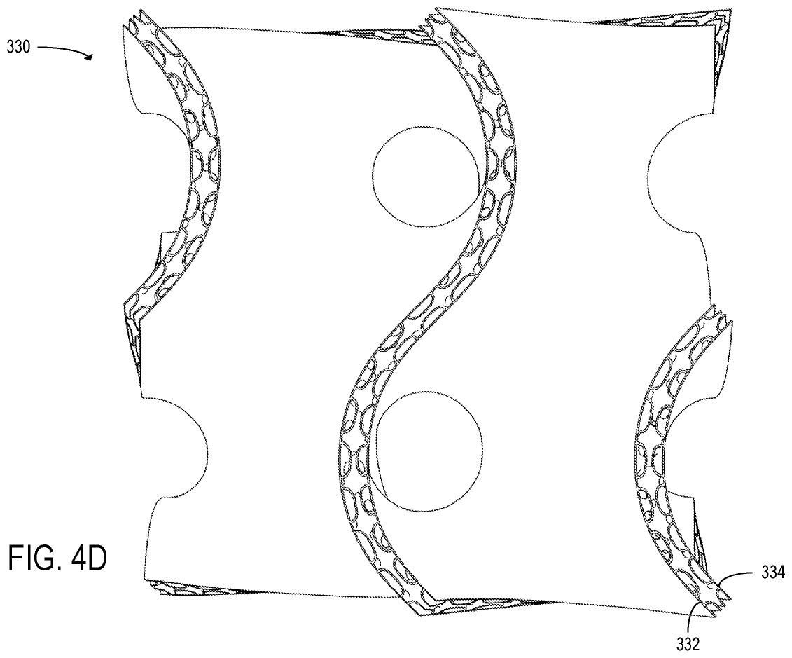

FIG. 4A shows another example of a target unit cell mesh 300. The target unit cell mesh 300 of FIG. 4A has a gyroid geometry, as defined by Equation 1. The target unit cell mesh 300 of FIG. 4A includes a plurality of target quadrilateral elements 302 that have smaller average sizes than the target quadrilateral elements 212 of the target unit cell mesh 210 shown in FIG. 3B. FIG. 4B shows an example target hexahedral unit cell mesh 310 that includes a plurality of target hexahedral elements 312 generated by extruding the target quadrilateral elements 302 of FIG. 4A. The target hexahedral elements 312 are shown slightly shrunken for clarity.

FIG. 4C shows an example type <Gyroid, Connectable Cuboid> level 1 recursive supercell 320 generated with a connectable cuboid base unit cell surface geometry combined with a gyroid target unit cell surface geometry. The example type <Gyroid, Connectable Cuboid> level 1 recursive supercell 320 is shown without skins in the example of FIG. 4C. FIG. 4D instead shows an example type <Gyroid, Connectable Cuboid> level 1 recursive supercell 330 generated as in FIG. 4C but with a first skin 332 and a second skin 334 on opposite sides of the connectible cuboid unit cell. The connected cuboid unit cell has subsequently been mapped onto the gyroid unit cell.

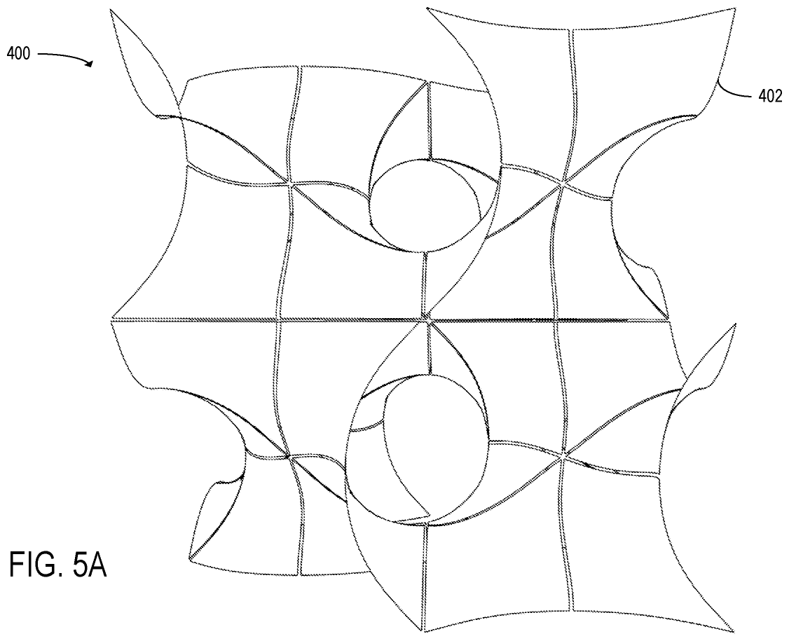

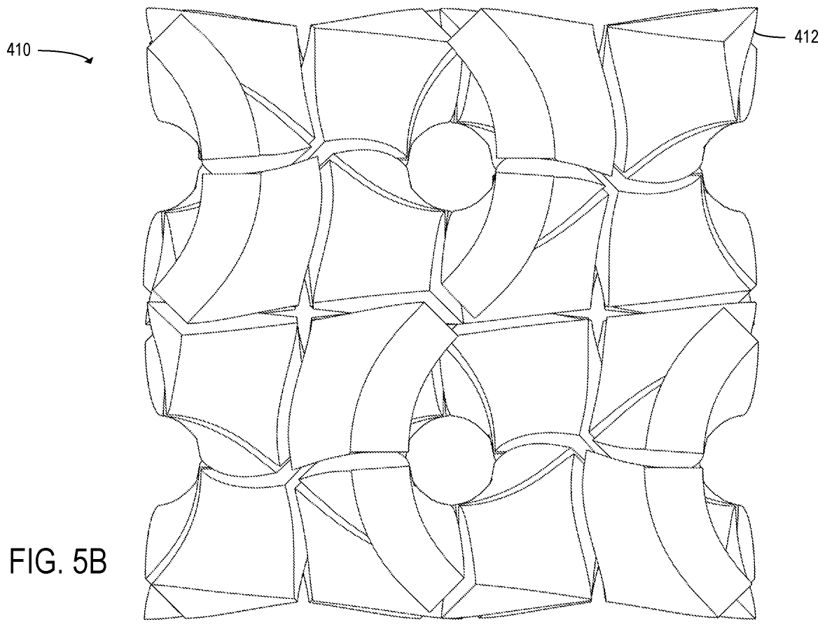

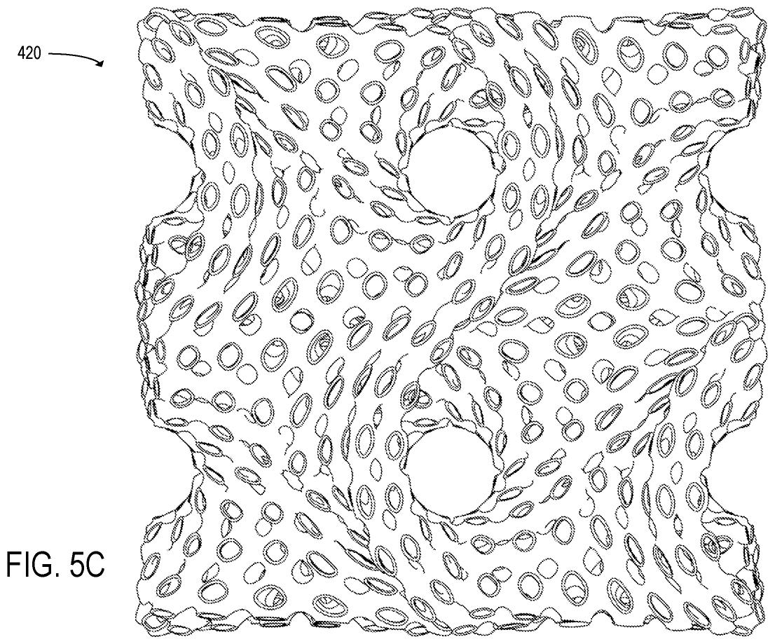

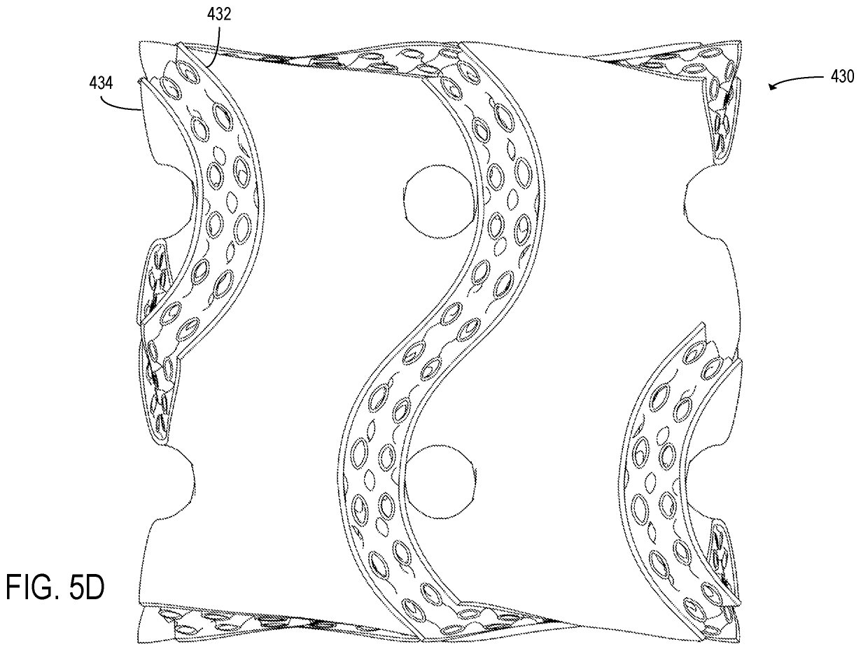

FIG. 5A shows an alternative target unit cell mesh 400 generated from the gyroid triply periodic minimal surface 200 of FIG. 3A. The target unit cell mesh 400 includes a plurality of target quadrilateral elements 402 that are larger on average than those of FIG. 3B or FIG. 4A. FIG. 5B shows an example target hexahedral unit cell mesh 410 generated from the target unit cell mesh 400 of FIG. 5A. The target hexahedral unit cell mesh 410 of FIG. 5B includes a plurality of target hexahedral elements 412, shown slightly shrunken for clarity.

FIG. 5C shows an example of a type <Gyroid, Multi-Layer Schwarz-P> level 1 recursive supercell 420 generated from the target gyroid hexahedral unit cell mesh 410 of FIG. 5B, with a Multi-Layer Schwarz-P base unit cell surface geometry. The multi-cell Schwarz-P base unit cell surface geometry includes a plurality of Schwarz-P base unit cells in each of the base unit cells that are mapped to the plurality of target hexahedral elements 412 included in the target hexahedral unit cell mesh 410. FIG. 5D shows another example type <Gyroid, Multi-Layer Schwarz-P> level 1 recursive supercell 430 generated as in FIG. 5C but with a first skin 432 and a second skin 434 located on opposite sides of the surface of the multi-layer Schwarz-P unit cell.

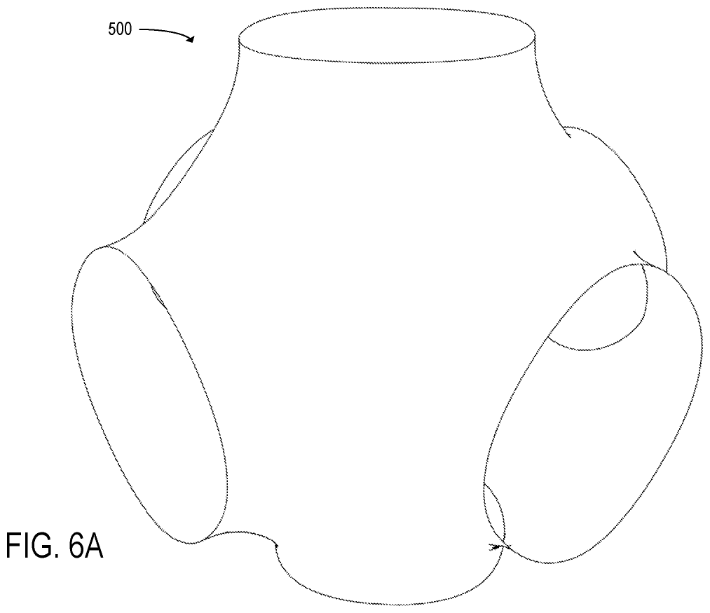

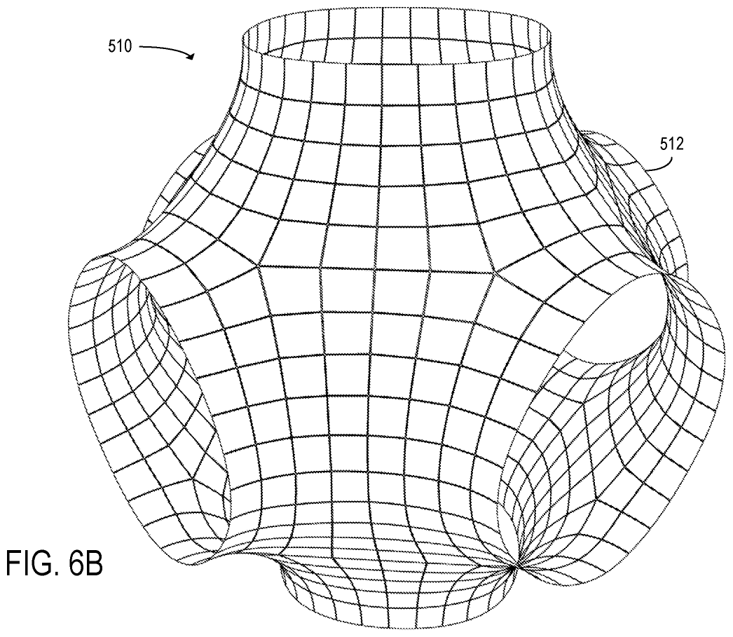

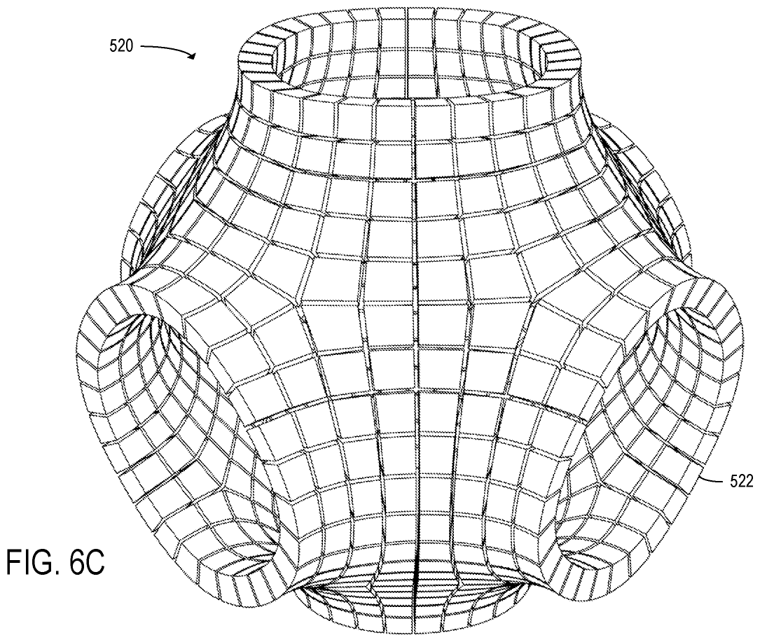

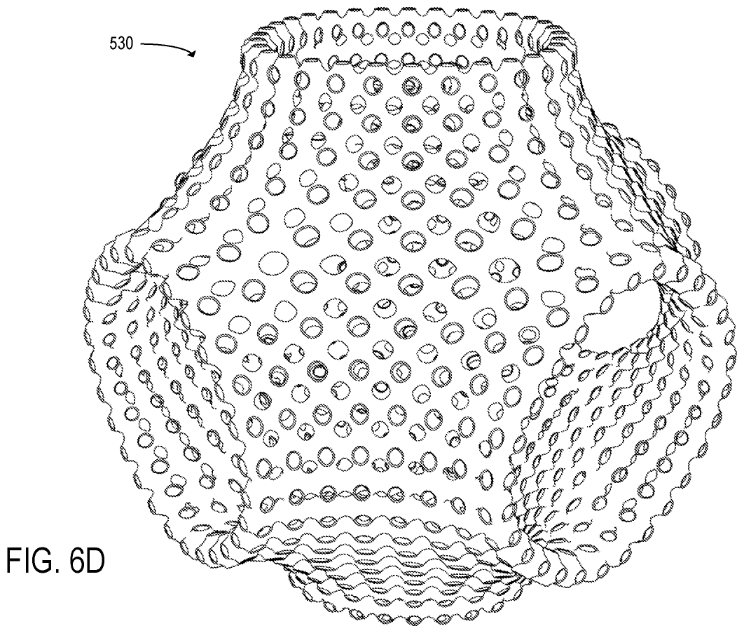

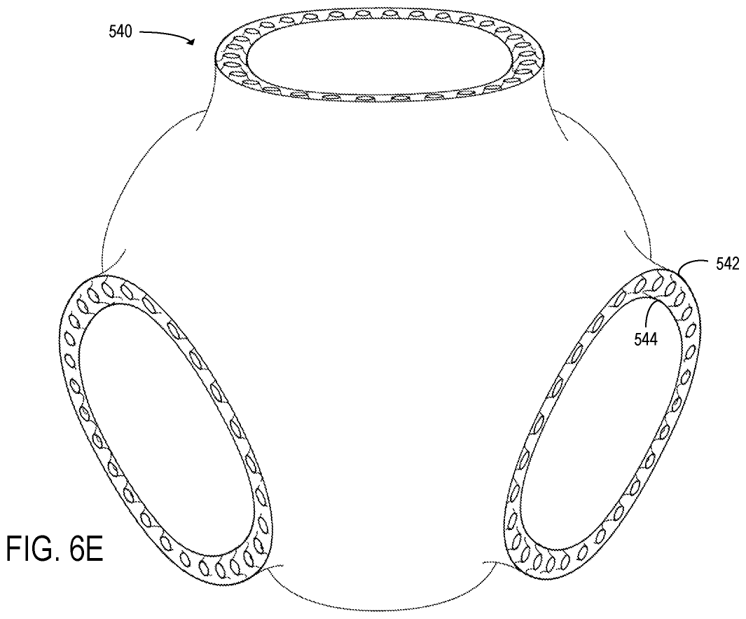

FIG. 6A shows an example triply periodic minimal surface 500 that has a Schwarz-P geometry, as defined by Equation 2. FIG. 6B shows an example target unit cell mesh 510 generated to conform to the Schwarz-P geometry of the triply periodic minimal surface 500 of FIG. 6A. The target unit cell mesh 510 includes a plurality of target quadrilateral elements 512. FIG. 6C shows an example target hexahedral unit cell mesh 520 generated from the target unit cell mesh 510 of FIG. 6B. The target hexahedral unit cell mesh 520 of FIG. 6C includes a plurality of target hexahedral elements 522. The target hexahedral elements 522 are shown slightly shrunken for clarity.

FIG. 6D shows an example type <Schwarz-P, Schwarz-P> level 1 recursive supercell 530 generated from the target hexahedral unit cell mesh 520 of FIG. 6C, with a Schwarz-P unit cell surface geometry as both the base and the target unit cell surface geometry. In the example of FIG. 6D, the base unit cell mesh has the same shape as the target unit cell mesh. FIG. 6E shows another example type <Schwarz-P, Schwarz-P> level 1 recursive supercell 540 generated as in FIG. 6D but with a first skin 542 and a second skin 544.

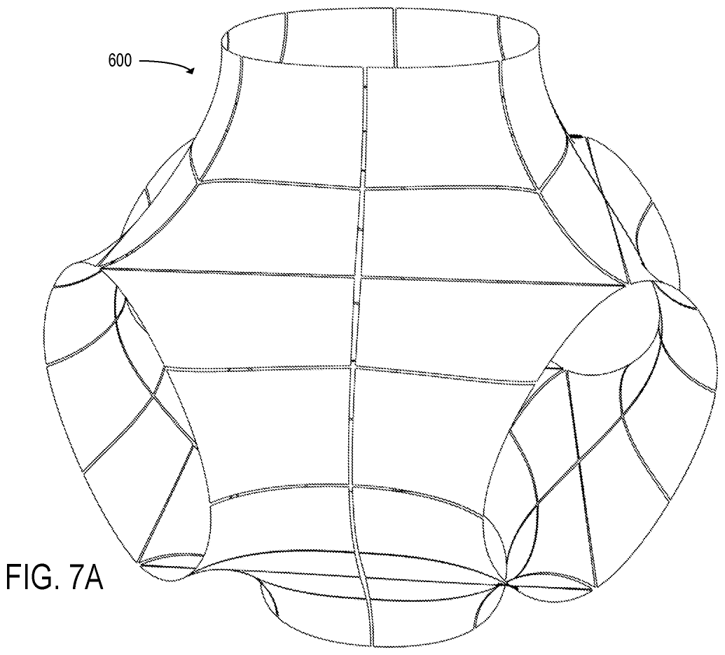

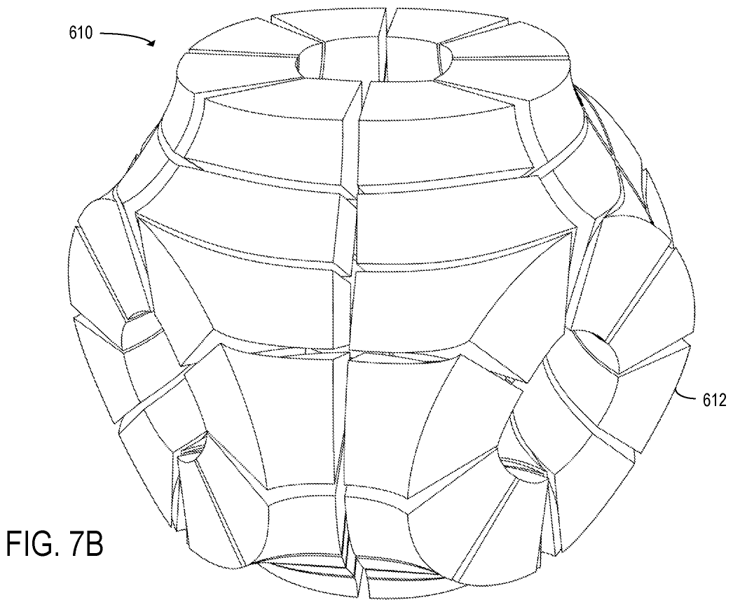

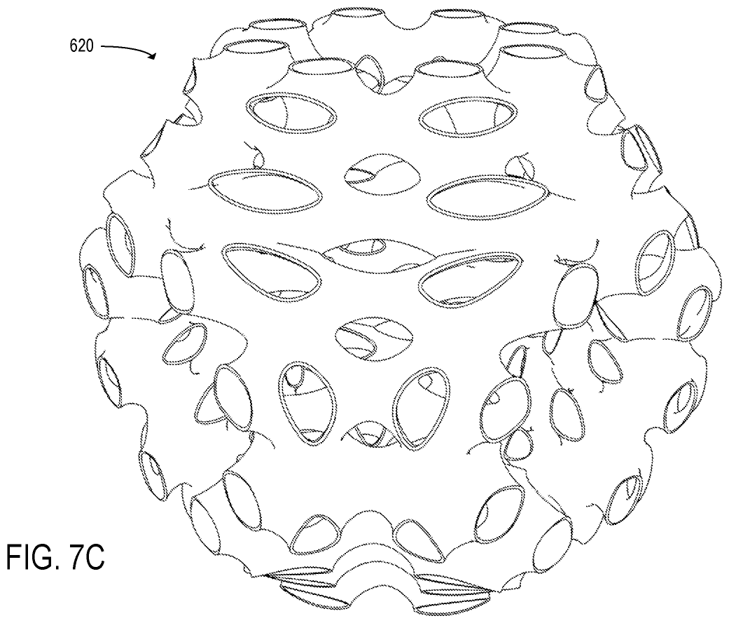

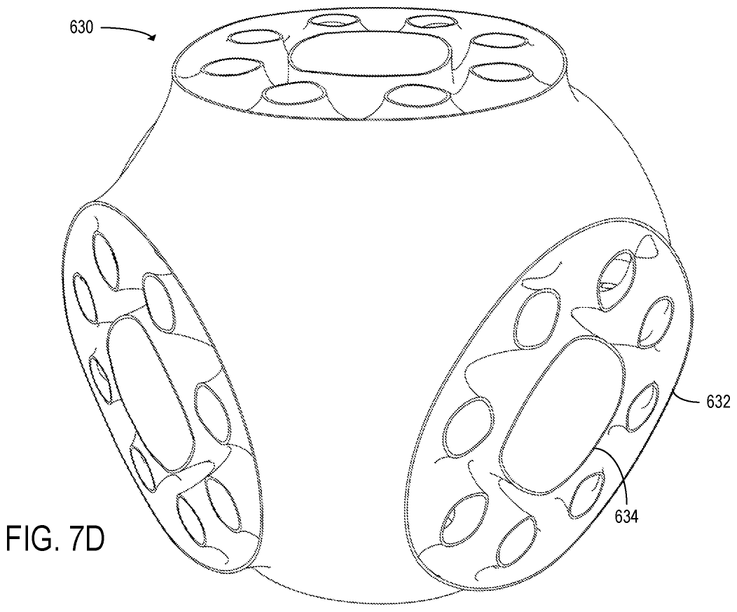

FIG. 7A shows another example target unit cell mesh 600 generated from the triply periodic minimal surface 500 of FIG. 6A. The target quadrilateral elements 602 of the target unit cell mesh 600 are larger on average than the target quadrilateral elements 512 depicted in FIG. 6B. FIG. 7B shows an example target hexahedral unit cell mesh 610 that is generated from the target unit cell mesh 600 of FIG. 7A and includes a plurality of target hexahedral unit cells 612, which are shown slightly shrunken for clarity.

FIG. 7C shows an example type <Schwarz-P, Schwarz-P> level 1 recursive supercell 620 generated using the target hexahedral unit cell mesh 610. In the example unit supercell 620, both the base unit cell geometry and the target unit cell geometry are a Schwarz-P unit cell surface geometry. FIG. 7D shows another example type <Schwarz-P, Schwarz-P> level 1 recursive supercell 630 generated from the target hexahedral unit cell mesh 610 that has a Schwarz-P base unit cell surface geometry and a Schwarz-P target unit cell surface geometry. The type <Schwarz-P, Schwarz-P> level 1 recursive supercell 630 further includes a first skin 632 and a second skin 634 on opposite sides of the Schwarz-P unit cell mesh used as the base unit cell. In this example, the Schwarz-P target unit cell mesh used as the target unit cell does not have skins.

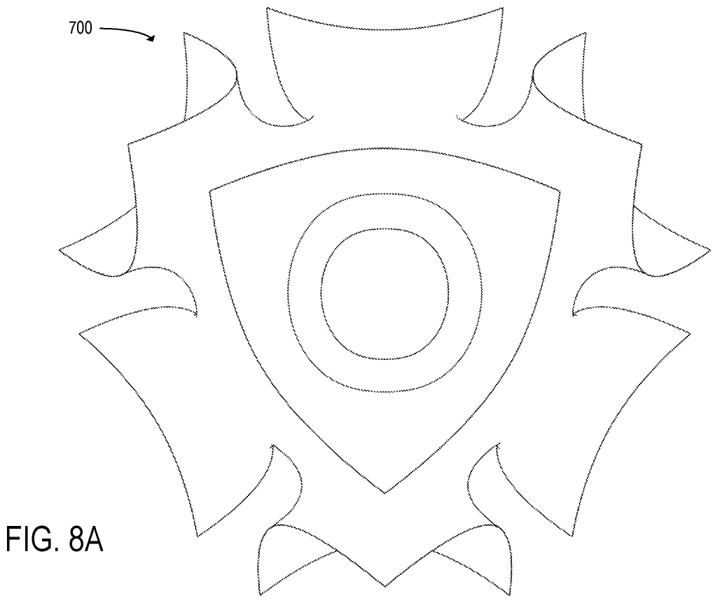

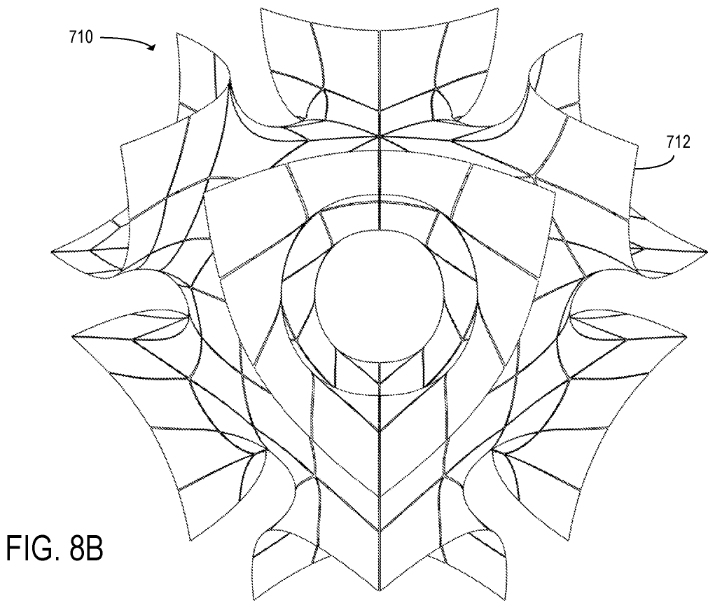

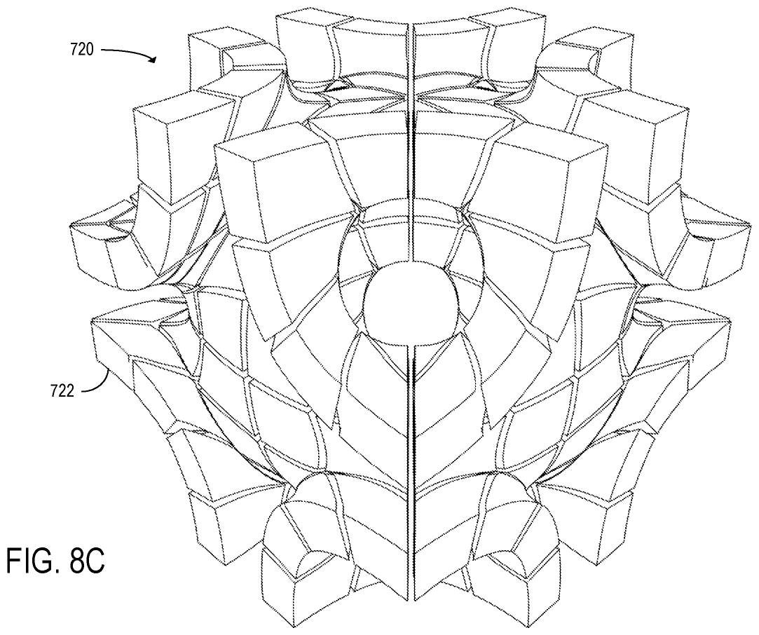

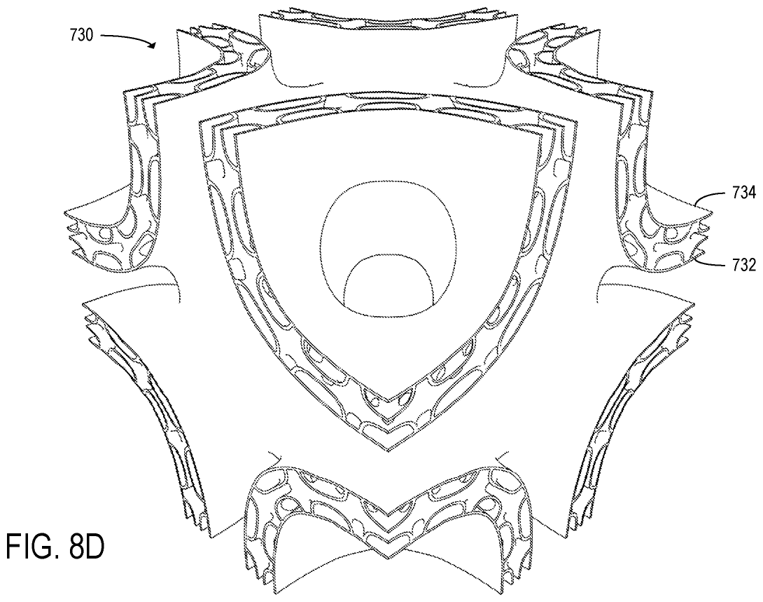

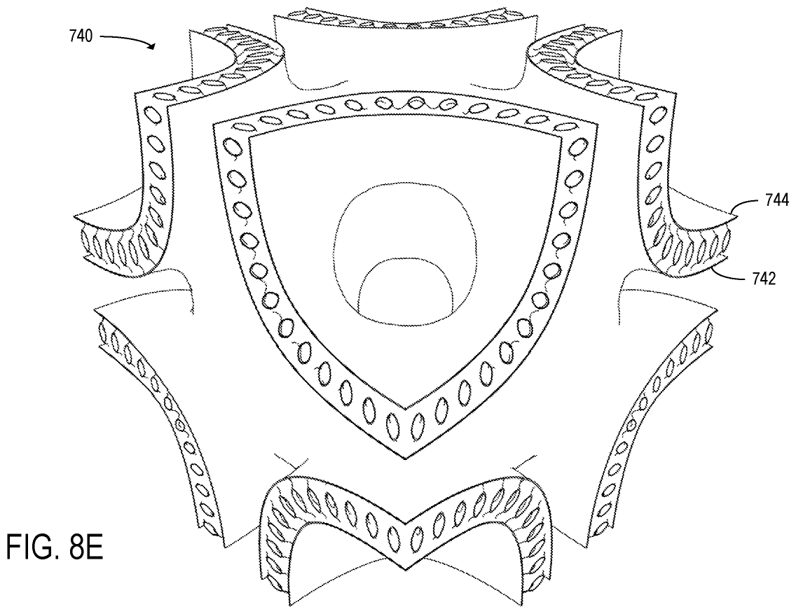

FIG. 8A shows an example triply periodic surface 700 that has a connectable cuboid geometry, as defined by Equation 3. FIG. 8B shows an example target unit cell mesh 710 that is generated to conform to the triply periodic surface 700 of FIG. 8A. The target unit cell mesh 710 of FIG. 8B includes a plurality of target quadrilateral elements 712. FIG. 8C shows an example target hexahedral unit cell mesh 720 that is generated using the target unit cell mesh 710 of FIG. 8B and includes a plurality of target hexahedral elements 722.

FIG. 8D shows an example type <Connectable Cuboid, Connectable Cuboid> level 1 recursive supercell 730 generated using the target hexahedral unit cell mesh 720. In the unit supercell 730, the base unit cell surface geometry is a connectable cuboid geometry, and the target unit cell surface geometry is also a connectable cuboid geometry. The type <Connectable Cuboid, Connectable Cuboid> level 1 recursive supercell 730 further includes a first skin 732 and a second skin 734 located on opposite sides of the connectable cuboid unit cell mesh used as the base unit cell. In this example, the connectable cuboid unit cell mesh used as the target unit cell does not have skins. FIG. 8E shows a type <Connectable Cuboid, Schwarz-P> level 1 recursive supercell 740 generated from the target hexahedral unit cell mesh 720. In the example recursive supercell 740 of FIG. 8E, the base unit cell surface geometry is a Schwarz-P geometry, and the target unit cell geometry is a connectable cuboid geometry. The base Schwarz-P unit cell geometry of the recursive supercell 740 of FIG. 8E includes a first skin 742 and a second skin 744. However, the target unit cell does not include a first or a second skin.

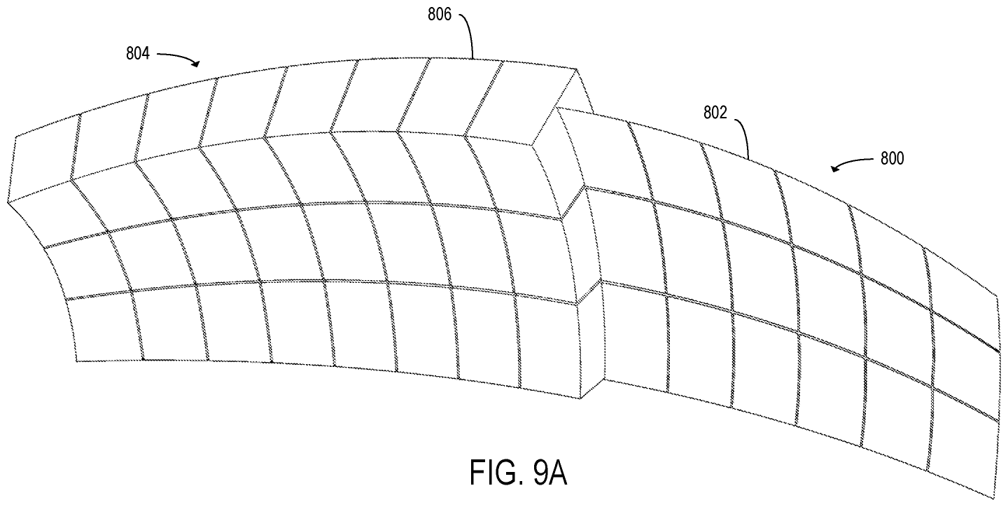

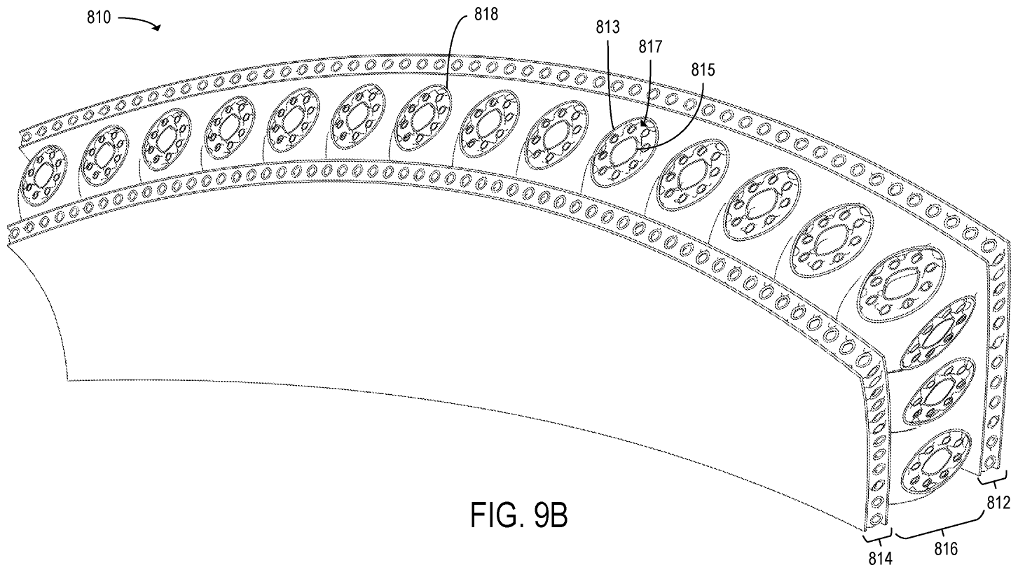

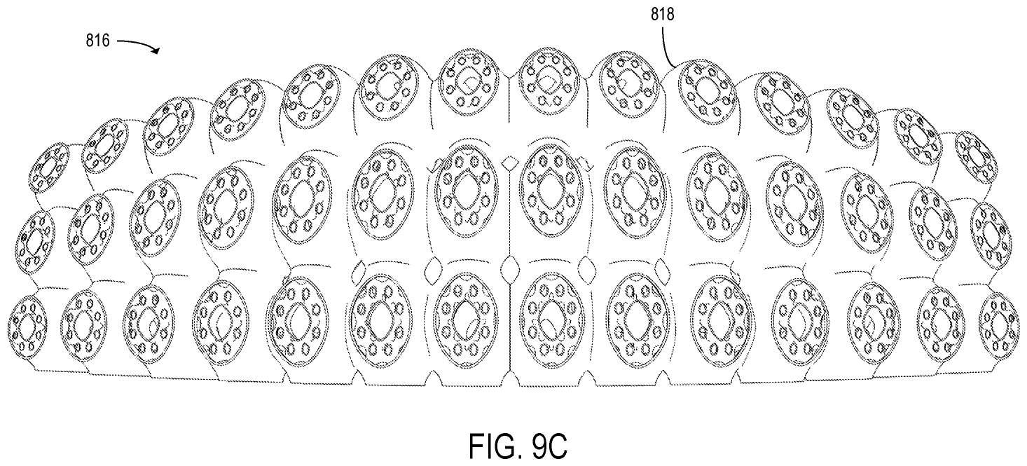

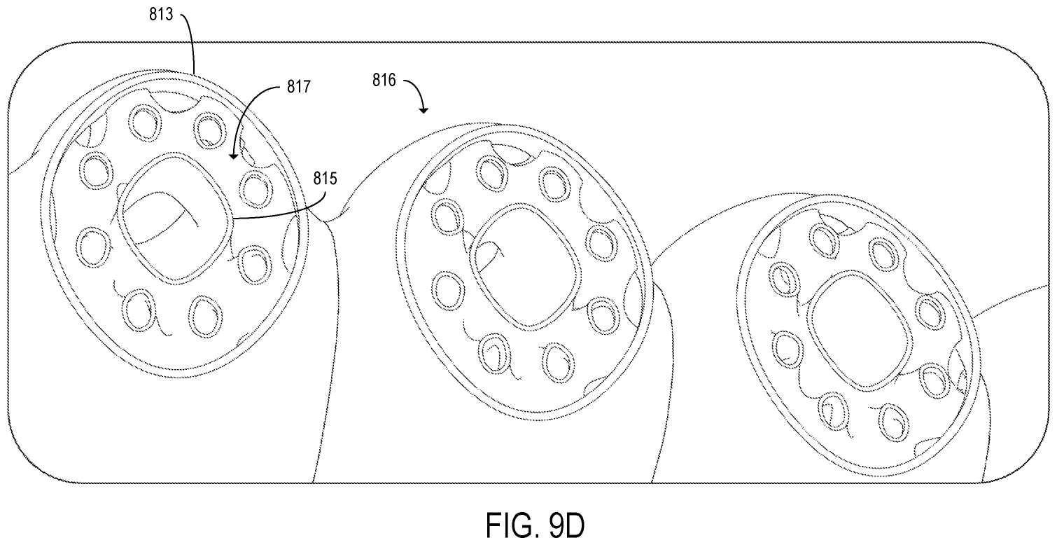

FIGS. 9A-9D show an example in which a sandwich panel geometry is computed at least in part by mapping the final recursive supercell mesh onto a mid-surface driver mesh. FIG. 9A shows an example mid-surface driver mesh 800 that defines a mid-surface of the sandwich panel geometry. The right half of FIG. 9A shows a portion of the plurality of quadrilateral elements 802 that form the mid-surface driver mesh 800. The left half of FIG. 9A shows a portion of the hexahedral elements 806 that form the target hexahedral unit cell mesh 804 extruded from the driver mesh 800.

FIG. 9B shows an example sandwich panel geometry 810 computed using the mid-surface driver mesh 800. The sandwich panel geometry 810 includes a plurality of type <Schwarz-P, Schwarz-P> level 1 recursive supercells 818. Both the base unit cell geometry and the target unit cell geometry are a Schwarz-P geometry. In this example of a type <Schwarz-P, Schwarz-P> level 1 recursive supercell 818, both the base unit cell and the target unit cell geometries include skins located on opposing sides of the Schwarz-P unit cell. The first skin 812, second skin 814 and infill 816 of the largest scale Schwarz-P unit cell are shown in FIG. 9B. A first skin 813, a second skin 815 and an infill 817 of the finer-scale Schwarz-P unit cell are shown in FIGS. 9B-9D. The sandwich panel 810 is shown in the absence of first skin 812 and second skin 814 in FIG. 9C, providing more visibility of infill 816.

FIG. 9D shows an inset view of a portion of the sandwich panel infill 816. As depicted in the inset view, the sandwich panel infill 816 has a fine-scale level of internal structure defined and a next-larger level of internal structure. At the fine-scale level of internal structure, the sandwich panel infill 816 includes a first skin 813, a second skin 815, and an infill 817, as discussed above. Via the recursive unit cell structure of the sandwich panel geometry 810, a thinner overall wall thickness can be used for the same level of bending stiffness, thereby allowing the overall strength-to-weight ratio of the sandwich panel to be increased.

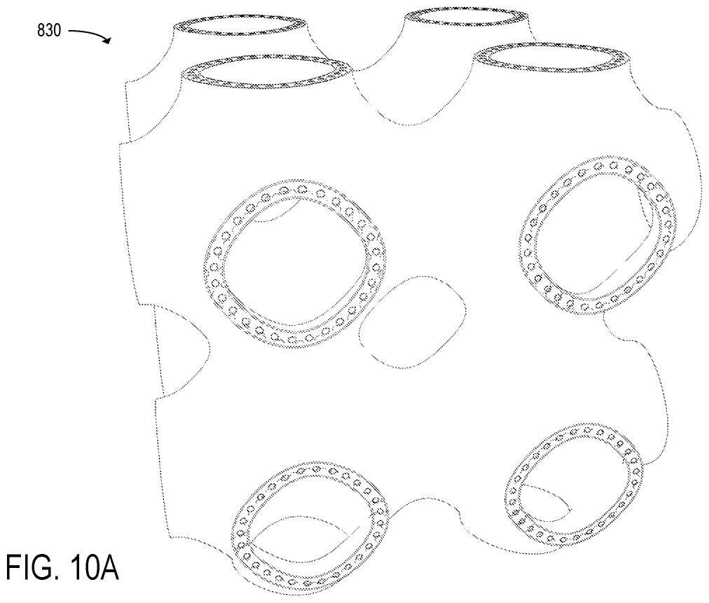

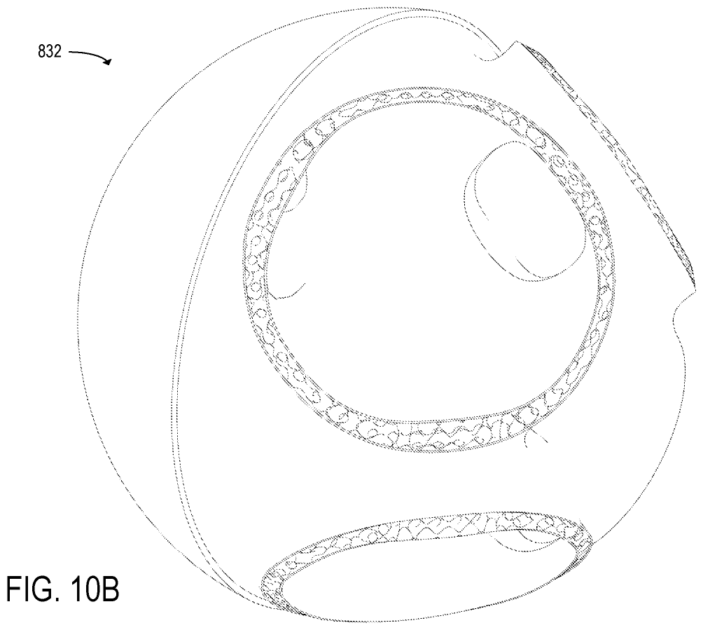

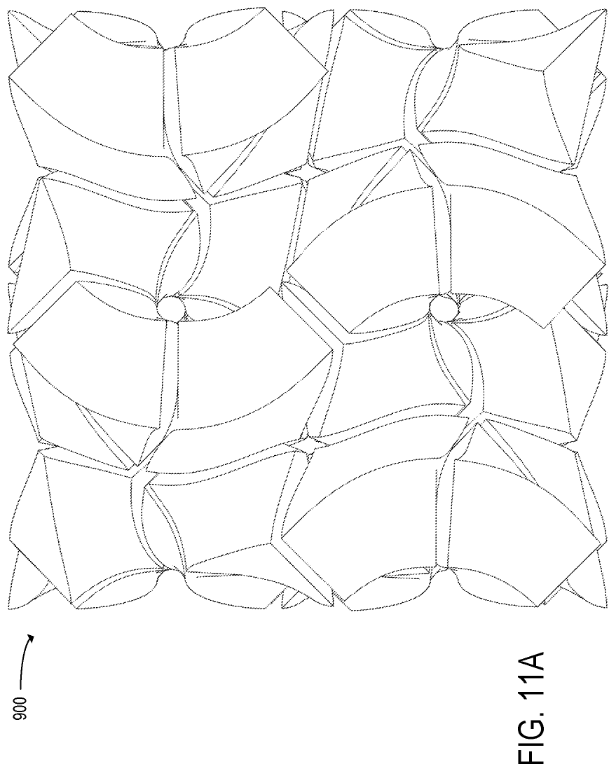

FIG. 10A shows an example 2×2×2 array 830 of type <Schwarz-P, Schwarz-P> level 1 recursive supercells. The array 830 can be generated to cover a part geometry of an additively manufacturable part, as discussed above with reference to FIG. 1C. FIG. 10B shows an example part geometry 832 of the additively manufacturable part. The part geometry 832 can be generated by computing a Boolean intersection of a solid sphere the array of the recursive supercells shown in FIG. 10A.

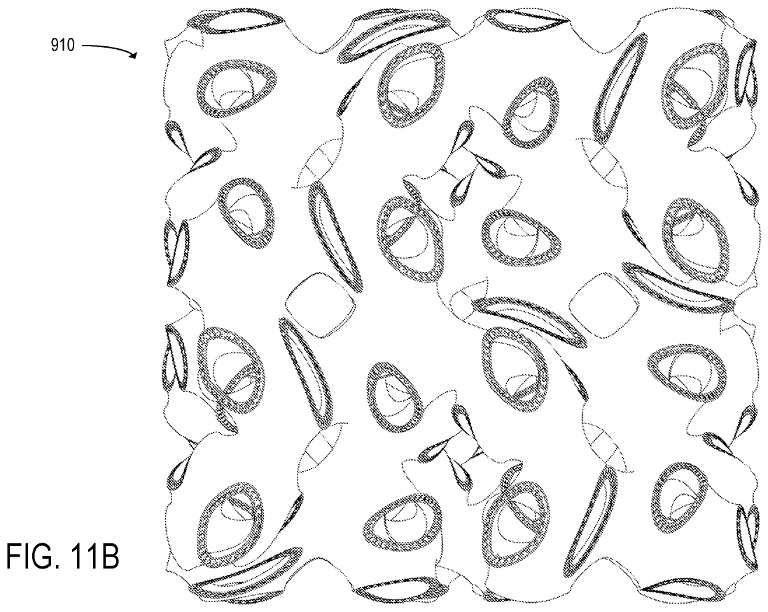

In some examples, as shown in FIGS. 11A-11B, the recursively mapped unit cell mesh is generated over more than one iteration. FIG. 11A shows a target hexahedral unit cell mesh 900 including a plurality of target hexahedral elements 902. The target hexahedral unit cell mesh 900 of FIG. 11A has been extruded from a quadrilateral mesh that conforms to a gyroid unit cell geometry, as defined by Equation 1. FIG. 11B shows an example type <Gyroid, Schwarz-P, Schwarz-P> level 2 recursive supercell 910 generated from the target hexahedral cell mesh 900 over two iterations. In the first iteration, the base unit cell mesh is generated from a Schwarz-P base unit cell surface geometry and the target unit cell mesh is also generated from a Schwarz-P surface geometry. The result of a first iteration of mapping is a type <Schwarz-P, Schwarz-P> level 1 recursive supercell. For example, the type <Schwarz-P, Schwarz-P> level 1 recursive supercell 540 of FIG. 6E can be used as the level 1 recursive supercell in the example of FIG. 11B. In the second iteration of mapping, the base unit cell surface mesh becomes the type <Schwarz-P, Schwarz-P> level 1 recursive supercell output by the first iteration. The target unit cell mesh is generated from a gyroid surface geometry (e.g., the target hexahedral unit cell mesh of FIG. 11A). The second iteration of mapping results in the type <Gyroid, Schwarz-P, Schwarz-P> level 2 recursive supercell 910. By generating the recursively mapped unit cell mesh over two iterations, the weight of the sandwich panel can be further decreased, since lower wall thicknesses can be used for the fine scale detail. In other examples, more than two iterations of mapping are used to generate the final supercell mesh.

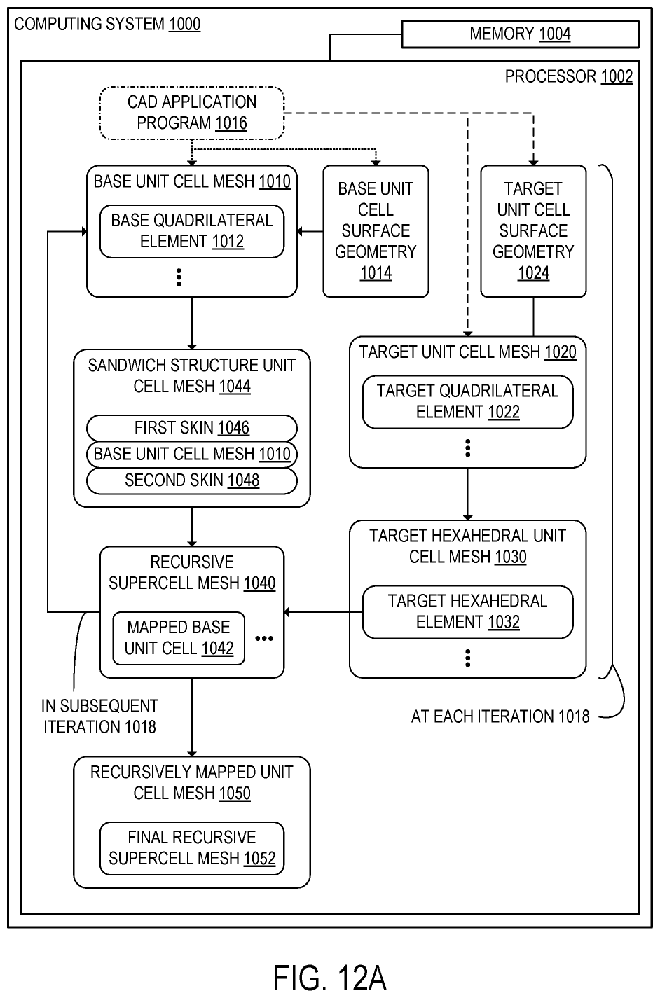

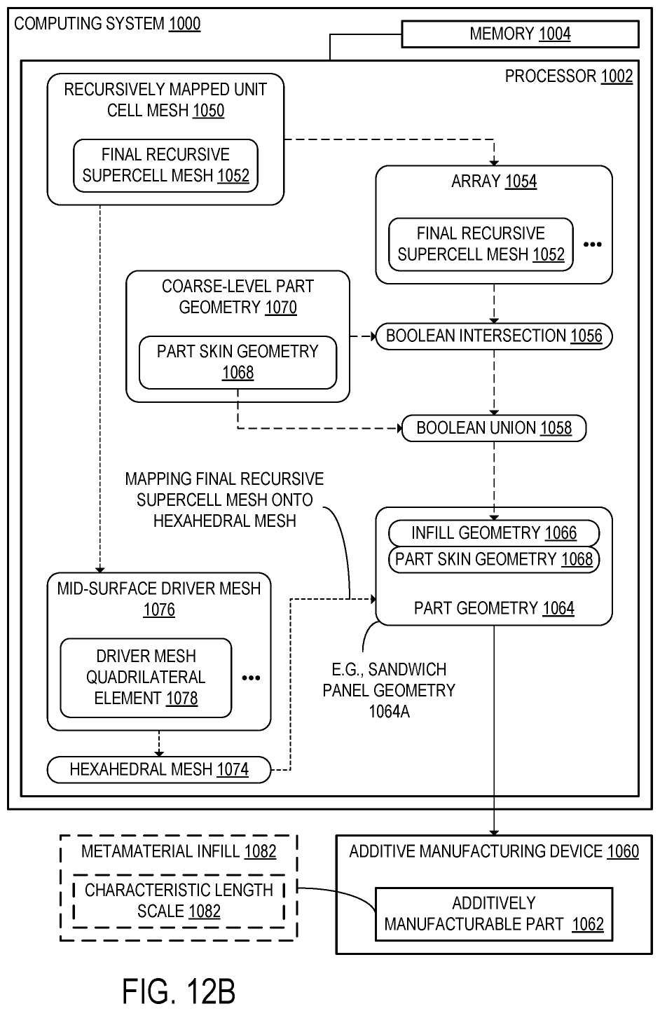

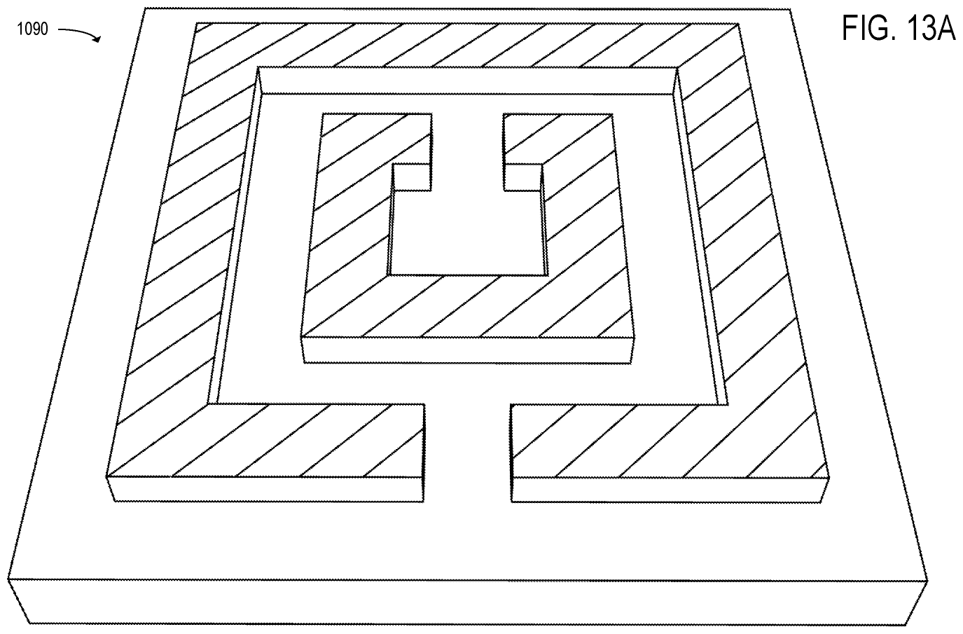

FIG. 12A schematically shows a computing system 1000, including a processor 1002 and memory 1004, that is configured to compute a recursively mapped unit cell mesh 1050. The processor 1002 and the memory 1004 can each be instantiated at one or more physical processing devices or memory devices, respectively. In some examples, the computing system 1000 is distributed across a plurality of physical computing devices. The computing system 1000 can also include other components such as one or more input devices and/or one or more output devices, as discussed in further detail below.

The processor 1002 is configured to receive or generate a base unit cell mesh 1010. The base unit cell mesh 1010 conforms to a base unit cell surface geometry 1014 and includes a plurality of base quadrilateral elements 1012. In some examples, the base unit cell surface geometry 1014 is defined by a periodic segment of a level set surface of a triply periodic scalar function that spans a three-dimensional Cartesian space. In such examples, base unit cell mesh 1010 may be generated by first employing a marching cubes or marching tetrahedron algorithm to generate a first mesh of triangles, utilizing a remeshing algorithm such as a Approximated Centroidal Voronoi Diagrams (ACVD) algorithm to generate a second mesh of triangles, and using a recombination algorithm such as a Blossom Recombination Algorithm to generate the base unit cell mesh 1010. Alternatively, the base unit cell surface geometry 1014 can be received from a CAD application program 1016, and the base unit cell mesh 1010 can be computed from the base unit cell surface geometry 1014 using a quadrilateral meshing algorithm.

The processor 1002 is further configured to perform a plurality of iterations 1018 over which the recursively mapped unit cell mesh 1050 is generated. In each of these iterations 1018, the processor 1002 is further configured to receive or generate a target unit cell mesh 1020 that defines a target unit cell surface geometry 1024 of a current iteration of the plurality of iterations 1018. The target unit cell mesh 1020 includes a plurality of target quadrilateral elements 1022. In some examples, the target unit cell mesh 1020 is also received from the CAD application program 1016.

The processor 1002 is further configured to generate a target hexahedral unit cell mesh 1030 including a plurality of target hexahedral elements 1032. The target hexahedral elements 1032 are generated at least in part by extruding the plurality of target quadrilateral elements 1022 included in the target unit cell mesh 1020 along respective directions normal to the surface of the target unit cell mesh 1020, above and below each target quadrilateral element 1022.

The processor 1002 is further configured to generate a recursive supercell mesh 1040 at least in part by mapping each of the base quadrilateral elements 1012 onto a respective target hexahedral element 1032 of the plurality of target hexahedral elements 1032 included in the target hexahedral unit cell mesh 1030. This mapping is performed using basis functions defined on the target quadrilateral elements 1022 or target hexahedral elements 1032. The recursive supercell mesh 1040 includes a plurality of mapped base unit cells 1042.

In some examples, as an additional step performed when computing the supercell mesh 1040, the processor 1002 is further configured to add a first skin 1046 and a second skin 1048 to the base unit cell mesh 1010 to thereby form a sandwich structure unit cell mesh 1044. In the sandwich structure unit cell mesh 1044, the first skin 1046 and the second skin 1048 are respectively located on opposite sides of the base unit cell mesh 1010.

If the current iteration 1018 is not a final iteration 1018 of the plurality of iterations 1018, the processor 1002 is further configured to set the recursive supercell mesh 1040 of the current iteration as the base unit cell mesh 1010 used in a subsequent iteration 1018. The processor 1002 is accordingly configured to generate a next level of structure for the recursively mapped unit cell mesh 1050 in the following iteration 1018. A final recursive supercell mesh 1052 computed in the final iteration 1018 is used as the recursively mapped unit cell mesh 1050.

The processor 1002 is further configured to output the recursively mapped unit cell mesh 1050. In the example of FIG. 12A, the processor 1002 is configured to output the recursively mapped unit cell mesh 1050 to be further used as either a mapped infill pattern or a background infill pattern for an additively manufacturable part 1062.

FIG. 12B schematically shows the computing system 1000 when additional computing processes are performed to generate a part geometry 1064 and manufacture an additively manufacturable part 1062 that has that part geometry 1064. In some examples, generating the part geometry 1064 includes constructing an array 1054 of recursive supercells that covers a part geometry 1070 of the additively manufacturable part 1062. The array 1054 includes a plurality of copies of the final recursive supercell mesh 1052. The part geometry 1070 is, in some examples, received from the CAD application program 1016. The part geometry 1070 includes a part skin geometry 1068 in the example of FIG. 12B. The processor 1002 is further configured to compute a Boolean intersection 1056 between the array 1054 of recursive supercells and the coarse-level part geometry 1070, minus a part skin geometry 1068 of the additively manufactured part 1062, to produce an infill geometry 1066. The processor 1002 is further configured to compute a Boolean union 1058 of the infill geometry 1066 and the part skin geometry 1068 to generate the part geometry 1064.

The part geometry 1064 is a sandwich panel geometry 1064A in some examples. In such an example, as shown in FIG. 12B, computing the part geometry 1064 instead includes mapping the final recursive supercell mesh 1052 onto a hexahedral mesh 1074. The hexahedral mesh 1074 is generated by extruding a mid-surface driver mesh 1076 that defines a mid-surface of the sandwich panel geometry 1064A and includes a plurality of driver mesh quadrilateral elements 1078. The processor 1002 is further configured to performing the mapping operations and output the sandwich panel geometry 1064A as a mesh.

FIG. 12B further shows an additive manufacturing device 1060 that is configured to manufacture the additively manufacturable part 1062. This additive manufacturing device 1060 is configured to receive the part geometry 1064 from the computing system 1000 and manufacture the additively manufacturable part 1062 as specified by the part geometry 1064. In some examples, the additively manufacturable part 1062 is formed from metal, ceramic, or a combination thereof, and is produced via one or more of laser powder bed fusion, selective laser melting, electron beam powder bed fusion, directed energy deposition, wire arc additive manufacturing, wire-feed electron beam additive manufacturing, binding jetting, supersonic particle deposition, and friction stir additive manufacturing. In other examples, the additively manufactured part is formed from a polymer and is produced via one or more of digital light processing, selective laser sintering, fused deposition modelling, material jetting, and stereolithography. Other materials and/or additive manufacturing techniques can be used in other examples.

In some examples, the additively manufacturable part 1062 includes a metamaterial infill 1082. Metamaterial infill 1082 includes an array of recursively mapped supercells and has one or more characteristic length scales 1080, which are length scales of a periodic structure of the metamaterial infill 1082. A characteristic length scale 1080 controls one or more behaviors of waves that interact with metamaterial infill 1082.

The relative sizes of each of the one or more characteristic length scales 1080 may be specified at the final recursive supercell mesh 1052 by specifying the amount of extrusion at each characteristic length scale 1080 and the average size of target quadrilateral elements 1080 in the target unit cell mesh 1020. Accordingly, at a given iteration, the mapped base unit cells 1042 have an average characteristic length scale 1080 that approximately matches the specified characteristic length scale 1080. As the amount of extrusion and the average size of target quadrilateral elements 1080 can be controlled at each iteration independently, a plurality of characteristic length scales 1080 can be achieved simultaneously in a final recursive supercell mesh 1052. An array of copies of the final recursive supercell mesh 1052 can then provide a metamaterial infill 1082. The metamaterial infill 1082 can subsequently be used as the infill of an additively manufacturable part 1062 in order to control one or more behaviors of waves that interact with additively manufactured part 1062.

In some examples, the waves are electromagnetic waves, and the one or more characteristic length scales 1080 are selected to elicit one or more electromagnetic wave behaviors. In other examples, the waves may be acoustic, and the one or more characteristic length scales 1080 are selected to elicit one or more acoustic wave behaviors. Example wavelength-related properties of the metamaterial 1082 can include selectively blocking, transmitting, amplifying, refracting, or absorbing waves where the characteristic length scale 1080 of metamaterial infill 1082 affects these behaviors. Other metamaterial properties can also be obtained in other examples by defining the internal structure of the metamaterial infill 1082 having one or more characteristic length scales 1080.

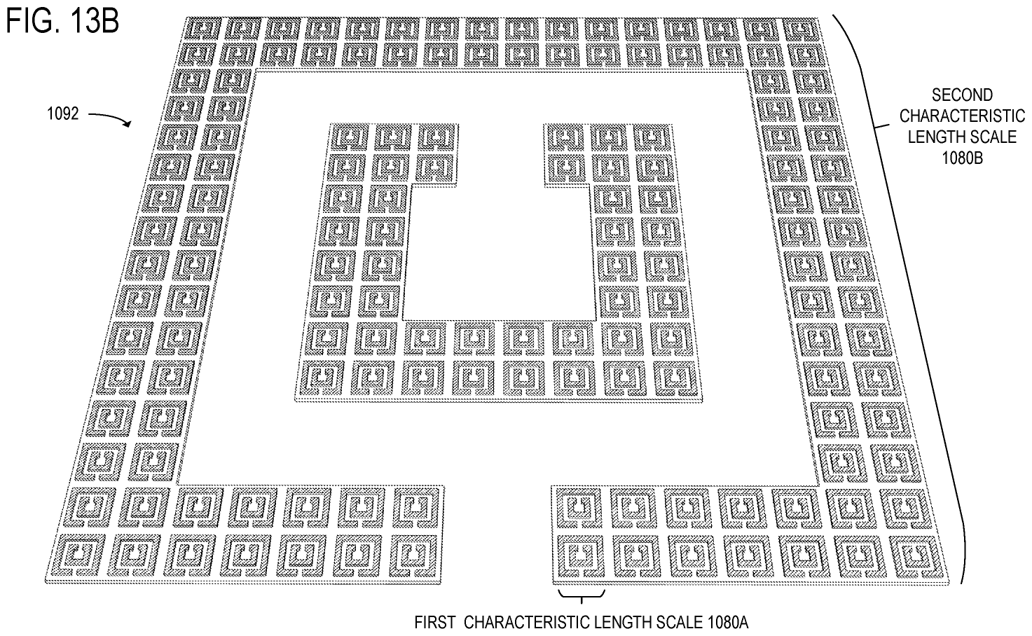

FIG. 13A schematically shows a split ring resonator base unit cell 1090 configured to be included in a metamaterial infill as a base unit cell. FIG. 13B schematically shows a metamaterial infill 1092 that is also structured as a split ring resonator. The metamaterial infill 1082 of FIG. 13B includes a plurality of smaller-scale split ring resonator base unit cells 1090 of FIG. 13A. Thus, the metamaterial infill 1092 of FIG. 13B acts approximately as a split ring resonator with two characteristic length scales 1080A and 1080B defined by the sizes of the split ring resonator base unit cell 1090 and the metamaterial infill 1092, respectively.

In some embodiments, the methods and processes described herein may be tied to a computing system of one or more computing devices. In particular, such methods and processes may be implemented as a computer-application program or service, an application-programming interface (API), a library, and/or other computer-program product.

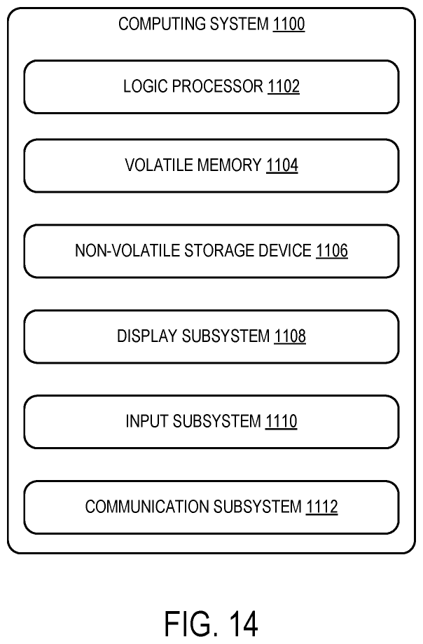

FIG. 14 schematically shows a non-limiting embodiment of a computing system 1100 that can enact one or more of the methods and processes described above. Computing system 1100 is shown in simplified form. Computing system 1100 may embody the computing system 1000 described above and illustrated in FIGS. 12A-12B. Components of computing system 1100 may be included in one or more personal computers, server computers, tablet computers, home-entertainment computers, network computing devices, video game devices, mobile computing devices, mobile communication devices (e.g., smart phone), and/or other computing devices, and wearable computing devices such as smart wristwatches and head mounted augmented reality devices.

Computing system 1100 includes a logic processor 1102 volatile memory 1104, and a non-volatile storage device 1106. Computing system 1100 may optionally include a display subsystem 1108, input subsystem 1110, communication subsystem 1112, and/or other components not shown in FIG. 14.

Logic processor 1102 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor 1102 may include one or more physical processors configured to execute software instructions. Additionally or alternatively, the logic processor may include one or more hardware logic circuits or firmware devices configured to execute hardware-implemented logic or firmware instructions. Processors of the logic processor 1102 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 1106 includes one or more physical devices configured to hold instructions executable by the logic processors to implement the methods and processes described herein. When such methods and processes are implemented, the state of non-volatile storage device 1106 may be transformed—e.g., to hold different data.

Non-volatile storage device 1106 may include physical devices that are removable and/or built in. Non-volatile storage device 1106 may include optical memory, semiconductor memory, and/or magnetic memory, or other mass storage device technology. Non-volatile storage device 1106 may include nonvolatile, dynamic, static, read/write, read-only, sequential-access, location-addressable, file-addressable, and/or content-addressable devices. It will be appreciated that non-volatile storage device 1106 is configured to hold instructions even when power is cut to the non-volatile storage device 1106.

Volatile memory 1104 may include physical devices that include random access memory. Volatile memory 1104 is typically utilized by logic processor 1102 to temporarily store information during processing of software instructions. It will be appreciated that volatile memory 1104 typically does not continue to store instructions when power is cut to the volatile memory 1104.

Aspects of logic processor 1102, volatile memory 1104, and non-volatile storage device 1106 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1100 typically implemented in software by a processor to perform a particular function using portions of volatile memory, which function involves transformative processing that specially configures the processor to perform the function. Thus, a module, program, or engine may be instantiated via logic processor 1102 executing instructions held by non-volatile storage device 1106, using portions of volatile memory 1104. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 1108 may be used to present a visual representation of data held by non-volatile storage device 1106. The visual representation may take the form of a graphical user interface (GUI). As the herein described methods and processes change the data held by the non-volatile storage device, and thus transform the state of the non-volatile storage device, the state of display subsystem 1108 may likewise be transformed to visually represent changes in the underlying data. Display subsystem 1108 may include one or more display devices utilizing virtually any type of technology. Such display devices may be combined with logic processor 1102, volatile memory 1104, and/or non-volatile storage device 1106 in a shared enclosure, or such display devices may be peripheral display devices.

When included, input subsystem 1110 may comprise or interface with one or more user-input devices such as a keyboard, mouse, touch screen, camera, or microphone.

When included, communication subsystem 1112 may be configured to communicatively couple various computing devices described herein with each other, and with other devices. Communication subsystem 1112 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 1100 to send and/or receive messages to and/or from other devices via a network such as the Internet.

Further, the disclosure comprises configurations according to the following clauses.

Clause 1. A method of generating a recursively mapped infill geometry for an additively manufacturable part, the method comprising: receiving a base unit cell mesh that defines a base unit cell surface geometry, wherein the base unit cell mesh includes a plurality of base quadrilateral elements; in each of a plurality of iterations: receiving a target unit cell mesh that defines a target unit cell surface geometry of a current iteration of the plurality of iterations, wherein the target unit cell mesh includes a plurality of target quadrilateral elements; generating a target hexahedral unit cell mesh including a plurality of target hexahedral elements at least in part by extruding the plurality of target quadrilateral elements; generating a recursive supercell mesh at least in part by mapping each of the base quadrilateral elements onto a respective target hexahedral element of the plurality of target hexahedral elements included in the target hexahedral unit cell mesh; and if the current iteration is not a final iteration of the plurality of iterations, setting the recursive supercell mesh of the current iteration as the base unit cell mesh to be used in a subsequent iteration; and outputting a recursively mapped unit cell mesh including a final recursive supercell mesh computed in the final iteration.

Clause 2. The method of Clause 1, further comprising adding a first skin and a second skin to the base unit cell mesh to thereby form a sandwich structure unit cell mesh that has the first skin and the second skin respectively located on opposite sides of the base unit cell mesh.

Clause 3. The method of Clause 1 or 2, further comprising: computing a sandwich panel geometry at least in part by mapping the final recursive supercell mesh onto a hexahedral mesh generated by extruding a mid-surface driver mesh that defines a mid-surface of the sandwich panel geometry and includes a plurality of driver mesh quadrilateral elements; and outputting the sandwich panel geometry as a mesh.

Clause 4. The method of Clause 1 or 2, further comprising: computing a part geometry of the additively manufacturable part by: constructing an array of recursive supercells that covers a coarse-level part geometry of additively manufacturable part; computing a Boolean intersection between the array of recursive supercells and the coarse-level part geometry, minus a part skin geometry of the additively manufacturable part, to produce an infill geometry; and computing a Boolean union of the infill geometry and the part skin geometry to generate the part geometry.

Clause 5. The method of any of Clauses 1-4, wherein the base unit cell surface geometry is a triply periodic minimal surface.

Clause 6. The method of any of Clauses 1-5, wherein the base unit cell and the target unit cell are a same unit cell.

Clause 7. The method of any of Clauses 1-6, wherein the base unit cell surface geometry is: a gyroid triply periodic minimal surface; a Schwarz-P triply periodic minimal surface; or a connectable cuboid triply periodic surface.

Clause 8. The method of any of Clauses 1-7, further comprising deleting duplicate nodes from the recursive supercell mesh.

Clause 9. An additively manufactured part with a part geometry that includes a plurality of recursively mapped unit cells, wherein the additively manufactured part is generated at least in part by: generating the part geometry at least in part by: receiving a base unit cell mesh that defines a base unit cell surface geometry, wherein the base unit cell mesh includes a plurality of base quadrilateral elements; in each of a plurality of iterations: receiving a target unit cell mesh that defines a target unit cell surface geometry of a current iteration of the plurality of iterations, wherein the target unit cell mesh includes a plurality of target quadrilateral elements; generating a target hexahedral unit cell mesh including a plurality of target hexahedral elements at least in part by extruding the plurality of target quadrilateral elements; generating a recursive supercell mesh at least in part by mapping each of the base quadrilateral elements onto a respective target hexahedral element of the plurality of target hexahedral elements included in the target hexahedral unit cell mesh; and if the current iteration is not a final iteration of the plurality of iterations, setting the recursive supercell mesh of the current iteration as the base unit cell mesh used in a subsequent iteration; and outputting a recursively mapped unit cell mesh including a final recursive supercell mesh computed in the final iteration; computing the part geometry, including a plurality of copies of the recursively mapped unit cell mesh; and producing the additively manufactured part at the additive manufacturing device as specified by the part geometry.

Clause 10. The additively manufactured part of Clause 9, wherein generating the part geometry further includes adding a first skin and a second skin to the base unit cell mesh to thereby form a sandwich structure unit cell mesh that has the first skin and the second skin respectively located on opposite sides of the base unit cell mesh.

Clause 11. The additively manufactured part of Clause 9 or 10, wherein generating the part geometry further includes: computing a sandwich panel geometry at least in part by mapping the final recursive supercell mesh onto a hexahedral mesh generated by extruding a mid-surface driver mesh that defines a mid-surface of the sandwich panel geometry and includes a plurality of driver mesh quadrilateral elements; and outputting the sandwich panel geometry as a mesh.

Clause 12. The additively manufactured part of Clause 9 or 10, wherein generating the part geometry further includes: constructing an array of recursive supercells that covers a coarse-level part geometry of the additively manufactured part; computing a Boolean intersection between the array of recursive supercells and the coarse-level part geometry, minus a part skin geometry of the additively manufactured part, to produce an infill geometry; and computing a Boolean union of the infill geometry and the part skin geometry to generate the part geometry.

Clause 13. The additively manufactured part of any of Clauses 9-12, wherein the base unit cell and the target unit cell are a same unit cell.

Clause 14. The additively manufactured part of any of Clauses 9-13, wherein the base unit cell surface geometry is: a gyroid triply periodic minimal surface; a Schwarz-P triply periodic minimal surface; or a connectable cuboid triply periodic surface.

Clause 15. The additively manufactured part of any of Clauses 9-14, wherein: the additively manufactured part is formed from metal, ceramic, or a combination thereof; and the additively manufactured part is produced via one or more of laser powder bed fusion, selective laser melting, electron beam powder bed fusion, directed energy deposition, wire arc additive manufacturing, wire-feed electron beam additive manufacturing, binding jetting, supersonic particle deposition, and friction stir additive manufacturing.

Clause 16. The additively manufactured part of any of Clauses 9-14, wherein: the additively manufactured part is formed from a polymer; and the additively manufactured part is produced via one or more of digital light processing, selective laser sintering, fused deposition modelling, material jetting, and stereolithography.

Clause 17. The additively manufactured part of any of Clauses 9-16, wherein the additively manufactured part is a metamaterial part that has one or more characteristic length scales defined by sizes of the target hexahedral elements in one or more respective iterations of the plurality of iterations.

Clause 18. The additively manufactured part of Clause 17, wherein the one or more characteristic length scales are electromagnetic wavelength scales.

Clause 19. A computing system comprising: a processor configured to: receive a base unit cell mesh that defines a base unit cell surface geometry, wherein the base unit cell mesh includes a plurality of base quadrilateral elements; in each of a plurality of iterations: receive a target unit cell mesh that defines a target unit cell surface geometry of a current iteration of the plurality of iterations, wherein the target unit cell mesh includes a plurality of target quadrilateral elements; generate a target hexahedral unit cell mesh including a plurality of target hexahedral elements at least in part by extruding the plurality of target quadrilateral elements; generate a recursive supercell mesh at least in part by mapping each of the base quadrilateral elements onto a respective target hexahedral element of the plurality of target hexahedral elements included in the target hexahedral unit cell mesh; and if the current iteration is not a final iteration of the plurality of iterations, set the recursive supercell mesh of the current iteration as the base unit cell mesh used in a subsequent iteration; output a final recursively mapped supercell mesh computed in the final iteration.

Clause 20. The computing system of Clause 19, wherein the processor is further configured to: generate a part geometry of an additively manufacturable part based at least in part on the final recursively mapped supercell mesh, wherein the part geometry is generated via mapping and/or one or more Boolean operations; and output the part geometry to an additive manufacturing device.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method of generating a recursively mapped infill geometry for an additively manufacturable part, the method comprising:
receiving a base unit cell mesh that defines a base unit cell surface geometry, wherein the base unit cell mesh includes a plurality of base quadrilateral elements;
in each of a plurality of iterations:
receiving a target unit cell mesh that defines a target unit cell surface geometry of a current iteration of the plurality of iterations, wherein the target unit cell mesh includes a plurality of target quadrilateral elements;
generating a target hexahedral unit cell mesh including a plurality of target hexahedral elements at least in part by extruding the plurality of target quadrilateral elements;
generating a recursive supercell mesh at least in part by mapping each of the base quadrilateral elements onto a respective target hexahedral element of the plurality of target hexahedral elements included in the target hexahedral unit cell mesh; and
if the current iteration is not a final iteration of the plurality of iterations, setting the recursive supercell mesh of the current iteration as the base unit cell mesh to be used in a subsequent iteration; and
outputting a recursively mapped unit cell mesh including a final recursive supercell mesh computed in the final iteration.

2. The method of claim 1, further comprising adding a first skin and a second skin to the base unit cell mesh to thereby form a sandwich structure unit cell mesh that has the first skin and the second skin respectively located on opposite sides of the base unit cell mesh.

3. The method of claim 1, further comprising:
computing a sandwich panel geometry at least in part by mapping the final recursive supercell mesh onto a hexahedral mesh generated by extruding a mid-surface driver mesh that defines a mid-surface of the sandwich panel geometry and includes a plurality of driver mesh quadrilateral elements; and
outputting the sandwich panel geometry as a mesh.

4. The method of claim 1, further comprising:
computing a part geometry of the additively manufacturable part by:
constructing an array of recursive supercells that covers a coarse-level part geometry of additively manufacturable part;
computing a Boolean intersection between the array of recursive supercells and the coarse-level part geometry, minus a part skin geometry of the additively manufacturable part, to produce an infill geometry; and
computing a Boolean union of the infill geometry and the part skin geometry to generate the part geometry.

5. The method of claim 1, wherein the base unit cell surface geometry is a triply periodic minimal surface.

6. The method of claim 1, wherein the base unit cell and the target unit cell are a same unit cell.

7. The method of claim 1, wherein the base unit cell surface geometry is:
a gyroid triply periodic minimal surface;
a Schwarz-P triply periodic minimal surface; or
a connectable cuboid triply periodic surface.

8. The method of claim 1, further comprising deleting duplicate nodes from the recursive supercell mesh.

9. An additively manufactured part with a part geometry that includes a plurality of recursively mapped unit cells, wherein the additively manufactured part is generated at least in part by:
generating the part geometry at least in part by:
receiving a base unit cell mesh that defines a base unit cell surface geometry, wherein the base unit cell mesh includes a plurality of base quadrilateral elements;
in each of a plurality of iterations:
receiving a target unit cell mesh that defines a target unit cell surface geometry of a current iteration of the plurality of iterations, wherein the target unit cell mesh includes a plurality of target quadrilateral elements;
generating a target hexahedral unit cell mesh including a plurality of target hexahedral elements at least in part by extruding the plurality of target quadrilateral elements;
generating a recursive supercell mesh at least in part by mapping each of the base quadrilateral elements onto a respective target hexahedral element of the plurality of target hexahedral elements included in the target hexahedral unit cell mesh; and
if the current iteration is not a final iteration of the plurality of iterations, setting the recursive supercell mesh of the current iteration as the base unit cell mesh used in a subsequent iteration; and
outputting a recursively mapped unit cell mesh including a final recursive supercell mesh computed in the final iteration;
computing the part geometry, including a plurality of copies of the recursively mapped unit cell mesh; and
producing the additively manufactured part at the additive manufacturing device as specified by the part geometry.

10. The additively manufactured part of claim 9, wherein generating the part geometry further includes adding a first skin and a second skin to the base unit cell mesh to thereby form a sandwich structure unit cell mesh that has the first skin and the second skin respectively located on opposite sides of the base unit cell mesh.

11. The additively manufactured part of claim 9, wherein generating the part geometry further includes:
computing a sandwich panel geometry at least in part by mapping the final recursive supercell mesh onto a hexahedral mesh generated by extruding a mid-surface driver mesh that defines a mid-surface of the sandwich panel geometry and includes a plurality of driver mesh quadrilateral elements; and
outputting the sandwich panel geometry as a mesh.

12. The additively manufactured part of claim 9, wherein generating the part geometry further includes:
constructing an array of recursive supercells that covers a coarse-level part geometry of the additively manufactured part;
computing a Boolean intersection between the array of recursive supercells and the coarse-level part geometry, minus a part skin geometry of the additively manufactured part, to produce an infill geometry; and
computing a Boolean union of the infill geometry and the part skin geometry to generate the part geometry.

13. The additively manufactured part of claim 9, wherein the base unit cell and the target unit cell are a same unit cell.

14. The additively manufactured part of claim 9, wherein the base unit cell surface geometry is:
a gyroid triply periodic minimal surface;
a Schwarz-P triply periodic minimal surface; or
a connectable cuboid triply periodic surface.

15. The additively manufactured part of claim 9, wherein:
the additively manufactured part is formed from metal, ceramic, or a combination thereof; and
the additively manufactured part is produced via one or more of laser powder bed fusion, selective laser melting, electron beam powder bed fusion, directed energy deposition, wire arc additive manufacturing, wire-feed electron beam additive manufacturing, binding jetting, supersonic particle deposition, and friction stir additive manufacturing.

16. The additively manufactured part of claim 9, wherein:
the additively manufactured part is formed from a polymer; and
the additively manufactured part is produced via one or more of digital light processing, selective laser sintering, fused deposition modelling, material jetting, and stereolithography.

17. The additively manufactured part of claim 9, wherein the additively manufactured part is a metamaterial part that has one or more characteristic length scales defined by sizes of the target hexahedral elements in one or more respective iterations of the plurality of iterations.

18. The additively manufactured part of claim 17, wherein the one or more characteristic length scales are electromagnetic wavelength scales.

19. A computing system comprising:
a processor configured to:
receive a base unit cell mesh that defines a base unit cell surface geometry, wherein the base unit cell mesh includes a plurality of base quadrilateral elements;
in each of a plurality of iterations:
receive a target unit cell mesh that defines a target unit cell surface geometry of a current iteration of the plurality of iterations, wherein the target unit cell mesh includes a plurality of target quadrilateral elements;
generate a target hexahedral unit cell mesh including a plurality of target hexahedral elements at least in part by extruding the plurality of target quadrilateral elements;
generate a recursive supercell mesh at least in part by mapping each of the base quadrilateral elements onto a respective target hexahedral element of the plurality of target hexahedral elements included in the target hexahedral unit cell mesh; and
if the current iteration is not a final iteration of the plurality of iterations, set the recursive supercell mesh of the current iteration as the base unit cell mesh used in a subsequent iteration;
output a final recursively mapped supercell mesh computed in the final iteration.

20. The computing system of claim 19, wherein the processor is further configured to:
generate a part geometry of an additively manufacturable part based at least in part on the final recursively mapped supercell mesh, wherein the part geometry is generated via mapping and/or one or more Boolean operations; and
output the part geometry to an additive manufacturing device.
